(19) United States
(12) Patent Application Publication
(10) Pub. No.: US 2005/0033770 A1
(43) Pub. Date: Feb. 10, 2005

(54) Dynamically evolving memory recall and idea generation tool

(76) Inventors: Katheryn E. Oglesby, Garden Grove, CA (US); Parth P. Mehta, Orange, CA (US)

Correspondence Address: WEIDE & MILLER, LTD., 7251 W. LAKE MEAD BLVD., SUITE 530, LAS VEGAS, NV, 89128, US

(21) Appl. No.: 10/637,818

(22) Filed: Aug. 7, 2003

(51) Int. Cl. G06F 17/00

(52) U.S. Cl. 707/104.1

(57) ABSTRACT

A memory recall aid and brain-storming tool comprises at least one database containing information regarding a plurality of topics, sub-topics, and filters, as well as words, concepts or phrases associated with the topics, sub-topics and filters. In accordance with a method and apparatus, words associated with selected topics or sub-topics are displayed. The words output may be filtered, or words associated only with a filter may be displayed. Topics or sub-topics with which a particular input word or words are associated are displayed, as are related words. In one embodiment, a method is provided for updating the database, such as by adding, changing or deleting database contents, such that it evolves dynamically over time. Other aspects of the invention comprise methods and systems for providing live support or assistance to a user of a computer application, and authenticating entitlement of a user to updated data.

### FIELD OF THE INVENTION

The present invention relates to memory recall aids and brain-storming tools, and particularly to a dynamically evolving tool using topics and words, including characteristics and associations of them, as an idea generator and memory recall aid.

### BACKGROUND OF THE INVENTION

In today's world, humans are exposed to an ever increasing amount of information. This information may be at a building block level, such as a new word or concept, or may be at an event or experience level, such as current news. Each of us stores or memorizes some or all of this information. The physical mechanism for memorization may be the same for each of us, but the results may differ. Each of us differs in our ability to store and retrieve information in our memory.

We are required to access and use the stored or memorized information for a variety of purposes. Some purposes are basic, such as remembering a telephone number or the name or a person. Other tasks are more complex, such as performing open heart surgery or flying an airplane. These more complex tasks may require the use of variety of different information. Even whenjust writing a letter, for example, we are required to form complex thoughts using the memorized information, including particular words and information regarding those words, such as their meaning. In some instances, we are also required to be creative and generate “ideas.” This creativity once again requires access to the variety of memorized information we have in our brain. How successful we are in generating these complex thoughts and the level of our creativity may depend, at least in part, upon our ability to access or recall the enormous amounts of memorized information.

One tool used to aid in accessing memorized information and using that information in forming complex or creative thoughts is called brain-storming. Brain-storming comprises engaging in acts or activities for the purpose of triggering or accessing the thoughts or information stored in the brain.

Brain-storming may be performed in various manners. One common way to brain-storm is to organize into a group of people and then engage in an open discussion. Because each persons' memorized information and the manner it is stored and grouped is different, such a discussion has the effect of triggering different reactions among the participants. The discussions thus may have the effect of “unlocking” information that a party would have otherwise had difficulty in retrieving or thinking of on their own.

Some tools have been devised to aid in this memory recall or brain-storming process. For example, each person may have their own techniques to aid them in recalling or thinking of information. A person may try and recall information by reference to a more general event, or by storing or memorizing the information in a certain way. To remember a particular activity or event, an age old trick is to tie a string around one's finger. This string serves as a memory link to information regarding the particular event or activity.

One brain-storming aid is described in U.S. Pat. No. 5,153,830 to Fisher et al. This patent describes a computerized aid for the creative process. The patent describes providing a database of thousands of questions. These questions are used, much as in verbal group brain-storming process, to clarify tasks, modify ideas and evaluate goals, ideas and outcomes.

The Fisher patent also describes providing a database of words and phrases. This information is stored in a hierarchy of major subject-matter categories, then topical categories, then sections within each topical category. The words and phrases are stored in an alphabetic or “alpha” list.

In accordance with the Fisher invention, a user may display the various categories. By selecting a particular section of a category, some words which are listed under that section may be displayed. An individual word may also be displayed, along with those words which are near that word in the alphabetical list. The user is not permitted, however, to see the entire list. The user may also obtain a list of the topical categories which contain a particular word or phrase.

The Fisher patent describes a tool which has many drawbacks or short-comings. As detailed in the patent, the database of words and phrases express the shared concepts of a particular culture. Thus, the database is decidedly very limited.

A particular disadvantage of the configuration of the invention described in the Fisher patent is the hierarchical structure of the categories, sections and words. In this configuration, the categories, sections and words are organized in a pyramid-type form. In accordance with this structure, a user can move down the structure by selecting a particular category and then particular section to obtain the words which are listed under that section.

This hierarchical structure does not take advantage of the way the brain works in storing and retrieving information. Namely, information is not necessarily stored in the brain in a hierarchical fashion. Often, the thought of one thing triggers the thought of something else which is tangential. In other words, the brain works in a “bi” or “multi” directional sense, not limited to a specific hierarchical flow. Thus, it is advantageous in a brain-storming session to move freely about associations or thoughts rather than in a determined straight-line hierarchical path.

It is an object of the invention to provide an improved memory recall and brain-storming aid or tool. Another object of the invention is to provide such a tool which changes or evolves over time.

### SUMMARY OF THE INVENTION

One embodiment of the invention comprises a memory recall aid and brain-storming tool. In one embodiment, the tool comprises data and computer executable program code for implementation by one or more computing devices. Preferably, the tool is configured to change or evolve over time.

In one embodiment of the invention, the tool comprises a system comprising at least one database containing information regarding a plurality of topics, information regarding one or more sub-topics associated with at least one topic, information regarding a plurality of filters, information regarding a plurality of words, concepts or phrases, and information associating the plurality of words, concepts or phrases with at least one topic or sub-topic and at least one filter. The system further includes means for generating a first output of words, concepts or phrases upon the selection of one or more topics or sub-topics, means for filtering the first output to generate a changed second output upon the selection of at least one particular filter, means for generating a third output of words, concepts or phrases upon the selection of only at least one filter, and means for displaying the one or more topics or sub-topics with which a particular word or words are associated.

In one embodiment, the means comprise an application embodied by software executed on a computing device. The software is configured to generate a graphical user interface for display on a display of the computing device. The graphical user interface includes a topics/sub-topics box or window in which topic and sub-topic information is displayed. The interface includes a filters box or window in which filter information is displayed. The interface also includes a words box or window in which one or more words, concepts or phrases are displayed, such as resulting from the selection of a particular topic, sub-topic and/or filter.

Various embodiments of the invention comprise generating information for use by a user. In one embodiment, the method comprises use of the system. Using the system, a user may use the application to generate information useful in aiding in memory recall and brain-storming. The user may obtain a list of words, concepts or phrases associated with a particular topic or a particular sub-topic. A user may obtain a list of words, concepts or phrases associated with a combination of topics and/or sub-topics. A user may filter the results with one or more filters, or may obtain a list of words, concepts or phrases associated with a particular filter. The user may also search a particular word or term, or combinations thereof. Such searching results in the identification of any matching topics or sub-topics, and the display of any related words.

In accordance with the invention, topic/sub-topic, filter and word information is associated or linked freely. A user may select upon broad topics, narrower sub-topics or filters to obtain specific or narrow word information. On the other hand, a user may select a word and obtain broader topic or sub-topic information. Words maybe associated or linked to a plurality of topics, sub-topics and filters.

The nature of the information and its association mimics the linked or associated nature of information stored in the human brain. As a result, output of the method/system is effective in aiding in memory recall and broad thought provocation.

As one aspect of the invention, the user may change the information contained in the database. For example, a user may add words, phrases or concepts, or may change the associations of particular words, phrases or concepts to particular topics, sub-topics or filters. Various embodiment of the invention thus comprise methods and systems for effecting such additions or changes.

In one embodiment, an individual user's database is changed locally based upon that user's input of additions or changes. In other instances, a group of user may use the same main database. In such instance, while the group of users may all use the same main database, at least one temporary database may contain the additions and/or changes by particular users. The main database may be updated at one or more times to reflect additions and/or changes input by particular users of the group.

In one embodiment, the main database is not updated without each addition or change going through an approval process. In one embodiment, a third party editor reviews the additions or changes. Selected additions or changes are flagged for acceptance. An administrator approves or disapproves the additions or changes for acceptance into the main database.

In one embodiment, use by users of the group is tracked, such as by a user identification process. Group users may obtain points or credits for suggesting additions or changes which are accepted into the main database.

In one embodiment, a provider maintains a master or global database. Additions or changes are made to this database from time to time. Some additions or changes are initiated by the provider. In a preferred embodiment, however, additions or changes made by individual users to their databases and by group users to their main database are polled and reviewed.

In accordance with this aspect of the invention, information generated by individual users is collected, screened or filtered and used to create a larger database of information. In this manner, the database of information grows quickly to be comprehensive and complete.

One aspect of the invention is a method and system for providing user assistance. This method and system has particular applicability to the memory recall aid of the invention, but is not limited to that application.

One embodiment of the invention thus comprises a method of providing information or assistance to a user of an application at a user computing device. This method comprises accepting input from the user of the application regarding a request for assistance and engaging in a user-assistance session. The user-assistance session includes the steps of establishing a communication link between the user's computing device and a provider device, generating an information display window at the user computing device, accepting input from the user of a request for assistance and displaying the request in the display window, transmitting the request to the provider device over the communication link, generating a response to the request, transmitting the request from the provider device to the user computing device over the communication link, and displaying the response to the user in the display window.

In accordance with this method, a user is provided with live, real-time assistance. This assistance is provided at the user's computer. In one form, the window comprises a “chat” window in which is displayed the text of requests, responses and other transmitted information.

In one embodiment, at the end of a session, the user inputs information regarding the outcome of the session. For example, the user may input that the outcome was “resolved” or “unresolved” as to the user's request. In the event the session is unresolved, a message is preferably generated. The message includes the outcome information as well as the information transmitted during the session. The message is preferably utilized by the provider to establish secondary contact with the user to resolve the request. For example, the original request may be addressed by a customer support person. The message may be sent to a supervisor. The supervisor may contact the user, such as by phone or e-mail, to resolve the otherwise unresolved session.

Another aspect of the invention is a method and system for authenticating a user's entitlement to data.

Further objects, features, and advantages of the present invention over the prior art will become apparent from the detailed description of the drawings which follows, when considered with the attached figures.

### DESCRIPTION OF THE DRAWINGS

FIG. 1 illustrates an exemplary main graphical user interface for implementing one embodiment of a method of the invention;

FIG. 2 illustrates one aspect of the implementation of the invention as providing information via a graphical user interface of the invention;

FIGS. 3(a)-(dd) illustrate block diagrams form various methods of the invention in which data is generated and output;

FIG. 4 illustrates a method of the invention in which a topic is selected and a resultant output thereof is displayed via a graphical user interface;

FIG. 5 illustrates a method of the invention in which a sub-topic is selected and a resultant output thereof is displayed via a graphical user interface;

FIG. 6 illustrates a method of the invention in which a filter is selected and a resultant output thereof is displayed via a graphical user interface;

FIG. 7 illustrates a method of the invention in which a topic and one or more filters are selected and the resultant output thereof is displayed via a graphical user interface;

FIG. 8 illustrates a method of the invention in which a sub-topic and one or more filters are selected and the resultant output thereof is displayed via a graphical user interface;

FIG. 9 illustrates a method of the invention in which multiple topics are selected and a resultant output thereof is displayed via a graphical user interface;

FIG. 10 illustrates a method of the invention in which multiple sub-topics are selected and a resultant output thereof is displayed via a graphical user interface;

FIG. 11 illustrates a method of the invention in which a topic and a sub-topic are selected and a resultant output thereof is displayed via a graphical user interface;

FIG. 12 illustrates a method of the invention in which a topic, a sub-topic and one or more filters are selected and the resultant output thereof is displayed via a graphical user interface;

FIG. 13 illustrates a method of the invention in which multiple topics and one or more filters are selected and a resultant output thereof is displayed via a graphical user interface;

FIG. 14 illustrates a method of the invention in which multiple sub-topics and one or more filters are applied and a resultant output thereof is displayed via a graphical user interface;

FIG. 15 illustrates a method of the invention in which multiple topics are compared and a resultant output thereof is displayed via a graphical user interface;

FIG. 16 illustrates a method of the invention in which multiple sub-topics are compared and a resultant output thereof is displayed via a graphical user interface;

FIG. 17 illustrates a method of the invention in which a topic and a sub-topic are compared and a resultant output thereof is displayed via a graphical user interface;

FIG. 18 illustrates a method of the invention in which multiple topics are compared and one or more filters are applied and a resultant output thereof is displayed via a graphical user interface;

FIG. 19 illustrates a method of the invention in which multiple sub-topics are compared and one or more filters are applied and a resultant output thereof is displayed via a graphical user interface;

FIG. 20 illustrates a method in which multiple topics and multiple sub-topics are compared, one or more filters are selected and a resultant output thereof is displayed via a graphical user interface;

FIG. 21 illustrates a method of the invention in which a single word is input and a resultant output thereof is displayed via a graphical user interface;

FIG. 22 illustrates a method of the invention in which a single word is input, a sub-topic is selected and a resultant output thereof is displayed via a graphical user interface;

FIG. 23 illustrates a method of the invention in which a single word is input and one or more filters are selected and a resultant output thereof is displayed via a graphical user interface;

FIG. 24 illustrates a method of the invention in which a single word is input, a sub-topic and one or more filters are selected and a resultant output thereof is displayed via a graphical user interface;

FIG. 25 illustrates a method of the invention where multiple words are input and compared and a resultant output thereof is displayed via a graphical user interface;

FIG. 26 illustrates a method of the invention where multiple words are input and compared and one or more sub-topics are selected and a resultant output thereof is displayed via a graphical user interface;

FIG. 27 illustrates a method of the invention where multiple words are input and compared and one or more filters are selected and a resultant output thereof is displayed via a graphical user interface;

FIG. 28 illustrates a method of the invention where multiple words are input and compared and one or more sub-topics and one or more filters are selected and a resultant output thereof is displayed via a graphical user interface;

FIG. 29 illustrates a method of the invention in which multiple words are input and combined and a resultant output thereof is displayed via a graphical user interface;

FIG. 30 illustrates a method of the invention in which multiple words are input and combined, one or more sub-topics are selected and a resultant output thereof is displayed via a graphical user interface;

FIG. 31 illustrates a method of the invention in which multiple words are input combined, one or more filters are selected and a resultant output thereof is displayed via a graphical user interface;

FIG. 32 illustrates a method of the invention in which multiple words are input combined, one or more sub-topics and one or more filters are selected and a resultant output thereof is displayed via a graphical user interface;

FIG. 33 illustrates a word contextual menu in accordance with an embodiment of the invention;

FIG. 34 illustrates multiple tabbed windows used to display information in accordance with the invention and use of a new tabbed window to conduct a new search;

FIG. 35 illustrates a method of selecting a transfer word function in accordance with an embodiment of the invention;

FIG. 36 illustrates a method of displaying a transferred word using a graphical user interface;

FIG. 37 illustrates a method of selecting an add association function in accordance with an embodiment of the invention;

FIG. 38 illustrates a graphical user interface for an add association function of the invention;

FIG. 39 illustrates a graphical user interface for implementing an add association function of the invention;

FIG. 40 illustrates a method of selecting a delete association function in accordance with an embodiment of the invention;

FIG. 41 illustrates a method of selecting a change association function in accordance with an embodiment of the invention;

FIG. 42 illustrates a graphical user interface for implementing a change association function of the invention;

FIG. 43 illustrates a method of selecting a filter, topic and/or sub-topic for association with a word using the graphical user interface illustrated in FIG. 42;

FIG. 44 illustrates a new filter, topic and/or sub-topic for association using the graphical user interface illustrated in FIG. 42;

FIG. 45 illustrates removal of a filter, topic and/or sub-topic for association and addition of a topic and sub-topic association using the graphical user interface illustrated in FIG. 42;

FIG. 46 illustrates a topic contextual menu in accordance with an embodiment of the invention;

FIG. 47 illustrates a method of renaming a topic using a graphical user interface;

FIG. 48 illustrates a method of deleting a topic using a graphical user interface;

FIG. 49 illustrates a method of merging topics using a graphical user interface;

FIG. 50 illustrates another aspect of a method of merging topics using a graphical user interface;

FIG. 51 illustrates a graphical user interface for implementing an add topic function of the invention;

FIG. 52 illustrates a sub-topic contextual menu in accordance with an embodiment of the invention;

FIG. 53 illustrates a method of renaming a sub-topic using a graphical user interface;

FIG. 54 illustrates a method of deleting a sub-topic using a graphical user interface;

FIG. 55 illustrates a method of merging sub-topics using a graphical user interface;

FIG. 56 illustrates another aspect of a method of merging sub-topics using a graphical user interface;

FIG. 57 illustrates a graphical user interface for implementing an add sub-topic function of the invention;

FIG. 58 illustrates one embodiment of an environment in which various embodiments of the invention may be implemented;

FIG. 59 is a flow chart illustrating a method of providing user support in accordance with another embodiment of the invention; and

FIG. 60 is a flow chart illustrating a method of authenticating entitlement of a user to access data or information, such as an application for implementing the methods of the invention and/or a database of information or database update.

### DETAILED DESCRIPTION OF THE INVENTION

The invention comprises various methods and apparatus for, among other things, assisting in memory recall and idea generation. Other methods, apparatus and systems are described. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a method for aiding in memory recall and the generation of ideas. Another embodiment is an apparatus, such as a system, configured to implement one or more methods of the invention.

A preferred embodiment of the invention is implemented in a computing environment. Such environments are well known and may vary. The invention may be implemented using appropriate hardware and/or software. For example, one embodiment of the invention can be implemented as computer software in the form of computer readable code executed on a general purpose computer, or in the form of bytecode class files executable within a Java™ runtime environment running on such a computer, or in the form of bytecodes running on a processor (or devices enabled to process bytecodes) existing in a distributed environment (e.g., one or more processors on a network).

As is known, the computer or computing device may include user input devices such as a keyboard and mouse which are coupled to a system bus. The keyboard and mouse are for introducing user input to the computer system and communicating that user input to a processor. Other suitable input devices may be used in addition to, or in place of, the mouse and keyboard.

The computing device may include a video memory, a main memory and a mass storage device, all coupled to the system bus along with the user input device or devices. The mass storage device may include both fixed and removable media, such as magnetic, optical or magnetic optical storage systems or any other available mass storage technology.

The processor may be a device such as microprocessor manufactured by any of a variety of manufacturers. The main memory may comprise RAM, SDRAM, Flash Memory, DDRAM or other types of memory devices. The output of the video memory may be coupled to a video amplifier. The video amplifier is used to drive a display, such as a CRT, plasma, LCD or LED type display.

In one embodiment, the computing environment may be a distributed or networked computing environment. For example, the computing device may comprise a host having associated stations. The host preferably includes a communication interface which is coupled to the system bus. The communication interface may provide a two-way data communication coupling via a network link to a local network. For example, if communication interface is an integrated services digital network (ISDN) card or a modem, communication interface provides a data communication connection to the corresponding type of telephone line, which comprises part of network link. If communication interface is a local area network (LAN) card, communication interface provides a data communication connection via network link to a compatible LAN. The communication interface may have a variety of architectures and utilized a variety of protocols such as EEE-1394 (FireWire™) or Ethernet in the case where the link is a wired link, or 802.11b or Bluetooth™ in the case of a wireless link. In any such implementation, communication interface sends and receives electrical, electromagnetic or optical signals which carry digital data streams representing various types of information.

The network link may provide data communication through one or more networks to other data devices. For example, the network link may provide a connection through the local network to a local server computer or to data equipment operated by an Internet Service Provider (ISP). The ISP may in turn provide data communication services through the world wide packet data communication network now commonly referred to as the “Internet.” The local network and Internet both use electrical, electromagnetic or optical signals which carry digital data streams.

The host can send messages and receive data, including program code, through the network(s), network link, and communication interface. In the Internet example, a remote server computer might transmit a requested code for an application program through the Internet, the ISP, the local network and the communication interface.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, and servers on a network.

The computer system comprising the host as described above is for purposes of example only. Embodiments of the invention may be implemented in any of a wide variety of computer systems or programming or processing environments.

Stations which may be used in the implementation of the invention may comprise a wide variety of devices. For example, each station may comprise a computing device similar to the host, but configured to carry out one or more other methods. In one embodiment, one or more of the stations comprise desk-top computing devices. In other embodiments, the stations may comprise lap-top or other portable computing devices, such as hand-held devices. Such hand-held devices may comprise personal data/digital assistants (PDAs) such as Palm Pilots™ manufactured by Palm Corp., or cellular phone devices.

Each station includes at least one input device. As described above, such devices may include a keyboard, mouse, keypad, touch screen or the like. Each station preferably includes a communication interface. The arrangement of the communication device depends on the manner in which data is to be communicated. For example, the communication interface may support wired or wireless communication, depending on whether the network link is wired or wireless.

In a preferred embodiment, each station includes a display for displaying information. The station also includes a processor for executing program code. The program code may be transmitted to the station from the host, or be resident at the station, such as in a memory device. The function and operation of each station is described in more detail below.

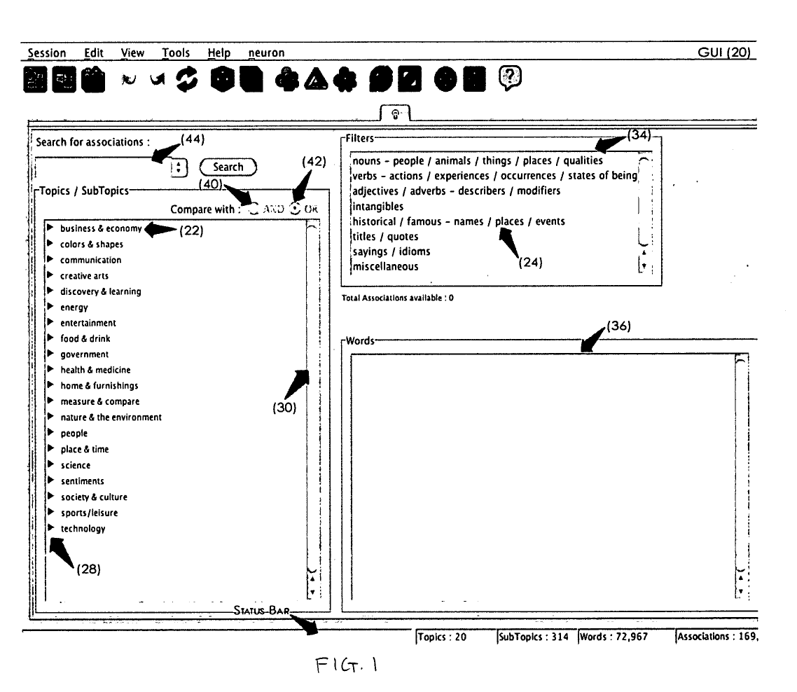

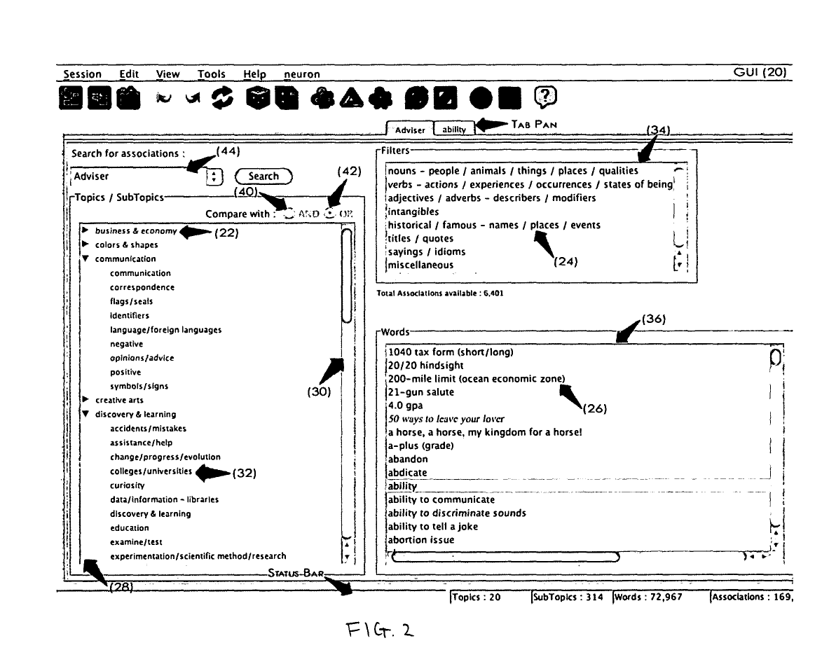

In one embodiment, computer readable program code or “software” is configured to perform various functions, including one or more methods of the invention. In one embodiment, as illustrated in FIG. 1, the computer readable program code is configured to generate a graphical user interface 20. The graphical user interface 20 may be displayed on a display associated with the computing device. As described above, the computer readable program code may be stored and executed at the computer or station where the information is displayed, or be executed remotely.

The graphical user interface 20 may have a variety of configurations. The graphical user interface 20 illustrated in FIG. 1 is exemplary of a graphical user interface 20 which may be used in the implementation of the invention. It will be appreciated that a variety of the functions and features of the invention may be implemented in other manners, including via other graphical user interfaces.

As illustrated, the graphical user interface 20 is configured to display information to a user. In one embodiment, the graphical user interface 20 is configured at one or more times to display information regarding one or more topics 22, to display information regarding one or more filters 24, and to display one or more words, phrases and/or concepts.

One embodiment of the invention comprises a plurality of topics 22. The topics 22 may be stored as information or data in one or more databases, such as at the computing device displaying the graphical user interface 20, or elsewhere.

As illustrated, the topics 22 may be displayed in a topic and sub-topic list or tree box 28. The particular topics 22, including their number and the particular subject-matter to which they pertain, may vary. The topics 22 may vary dependent upon the intended user, such as by differences in language (English, Spanish) or differences in culture or geographic location. Preferably, a great number of topics are provided.

As illustrated in FIG. 1, the topics 22 may be displayed in alphabetical order within the tree box 28. Means such as a scroll bar 30 may be provided for displaying information which can not be displayed in the tree box 28 at one time. As illustrated, for example, topics 22 may be listed in alphabetic order. The scroll bar 30 may be used to change the portion of the alphabetical list which is displayed in the tree box 28. Other means may be used, such as a “page up” key, not shown, to change the information which is displayed in the tree box 28.

Referring to FIG. 2, in one embodiment, one or more of the topics 22 contain or include one or more sub-topics 32. A topic 22 need not be broken into sub-topics 32. Preferably, sub-topics 32 are logically associated with a particular topic 22. For example, referring to FIG. 2, the exemplary “communication” topic 22 includes the exemplary sub-topics 32 “correspondence,” “flags/seals,” and “language/foreign language,” among others.

In one embodiment, a representation is provided of sub-topics 32 which are associated with a particular topic 22. In one embodiment, sub-topics 32 of a particular topic 22 may be displayed at one or more times in the tree box 28 under their associated topic 22. A topic 22 having sub-topics 32 may be positioned adjacent a “+” or “ [symbol] ” symbol, indicating that the topic 22 contains further information. As illustrated in FIG. 2, when the “ [symbol] ” symbol is selected, such as with a cursor, the sub-topic 32 information is preferably displayed under the topic 22. At that time, the “ [symbol] ” symbol changes to a “▴” or “−” or symbol, indicating that by selecting the “▴” symbol the user may cause the sub-topics 32 to no longer be displayed.

It will be appreciated that a wide variety of means may be provided for displaying the topics 22 and/or sub-topics 32. For example, a menu with selections may be provided or topics 22 may be configured as selectable buttons. In a preferred embodiment, sub-topics 32 are also displayed automatically upon selection of a particular topic 22.

Referring again to FIG. 1, one embodiment of the invention comprises a plurality of filters 24. The filters 24 may be stored as data in a database, such as at the computing device displaying the graphical user interface 24 or elsewhere.

As illustrated, the filters 24 may be displayed in a filters list box 34. The particular filters 24, including their number, may vary. A plurality of filters 24 are illustrated in FIG. 1.

Referring to FIG. 2, the invention also comprises a plurality of words, phrases or concepts 26. The number of words, phrases and/or concepts 26 may vary. In one embodiment, the words, phrases or concepts 26 are stored as data in a database, such as at the computing device displaying the graphical user interface 20 or elsewhere. As detailed below, the words, phrases or concepts 26 may be displayed within a words list box 36 which is a part of the graphical user interface 20. The words, phrases or concepts 26 may comprise words, groups of words, thoughts or the like, and/or may comprise symbols and numbers. The words, phrases or concepts 26 are preferably represented as text, but comprise or be represented or include images, punctuation, links and graphics. The words, phrases or concepts 26 may also include information traditionally provided in a thesaurus or dictionary function, such as synonyms.

In one embodiment, the words, phrases or concepts 26 are generally associated with one or more topics 22 and/or subtopics 32. In addition, the words, phrases or concepts 26 are classified by their applicability to one or more filters 24. In this manner, as described in greater detail below, words, phrases or concepts 26 may be obtained which pertain to particular topics 26 and/or subtopics 32, and may be filtered by using one or more filters 24.

In one embodiment, the various words, phrases or concepts 26 may be flagged or tagged to provide the associations. For example, the word “collie” may be associated with the topic “pet,” and thus information may be associated with that word so that this link or association exists. Similarly, the word “collie” maybe associated with the applicable filter “noun” and thus information or data may be associated with that word so that this link exists.

It will be appreciated that there may be multiple databases containing the topic/sub-topic, word and filter data or information. Alternatively, a single database may be utilized. Further, the associations or links between the topics/sub-topics, filter and words may be accomplished in a variety of fashions.

Preferably, the words, phrases or concepts 26 are associated with particular topics/sub-topics 22,32 and filters 24 based upon established or well-known associations. For example, particular words 26 may be associated with the noun or verb filters 24 based upon their classification as nouns or verbs in conventional and/or traditional English language dictionaries (such as Webster's Dictionary), and/or English language usage or lexicons. As described below, however, particular words, phrases or concepts 26 may be associated or linked to a particular topic/sub-topic 22,32 or filter 24 based upon user preference. The benefits of such flexibility are described in much greater detail below.

In one embodiment, information is displayed in panes displayed in the interface 20. Particular user activities, such as the results of a word search, topic selection or the like (described in detail below) may be displayed in separate panes. For example, referring to FIG. 2, the user has conducted two word searches, one for the terms “adviser” and one for the word “ability.” The results of each of these searches are displayed in individual panes. The most recently accessed pane is displayed on top. A tab indicates the presence of each pane and provides a summary of the activity to the user. This feature allows the user to engage in a plurality of activities and maintain the information related to each individual activity separate and active for future use. Of course, the user may also close the panes when they are not needed.

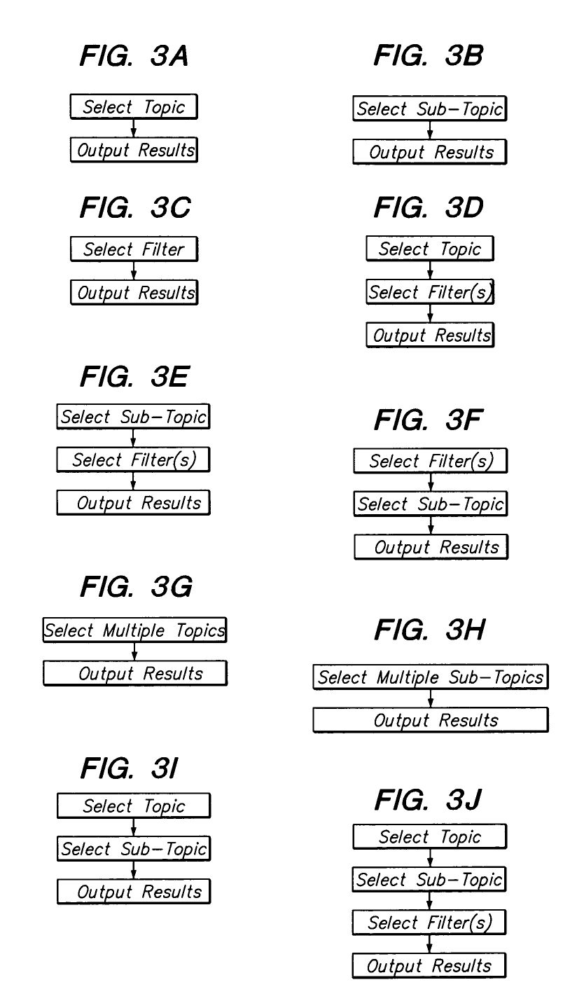

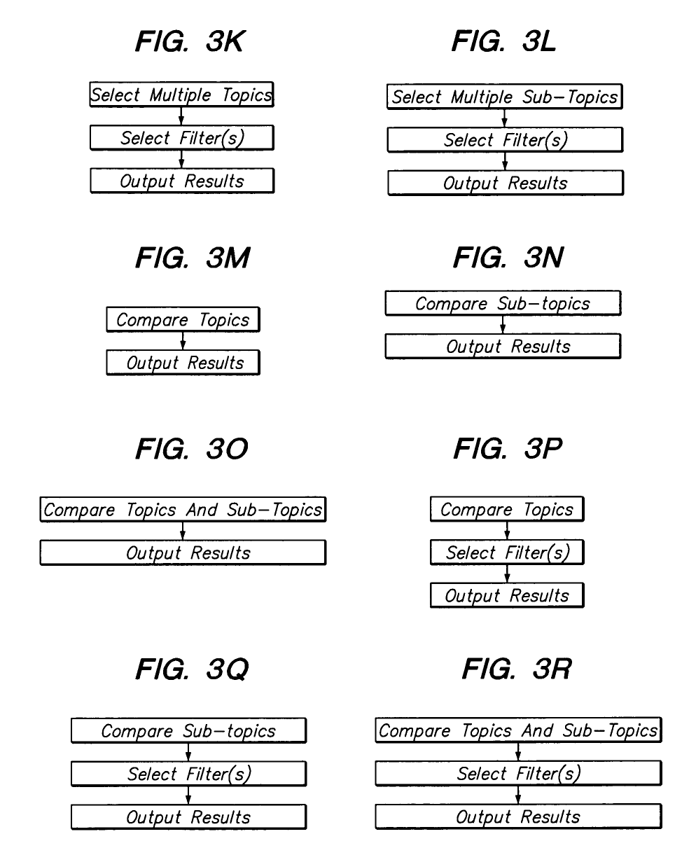

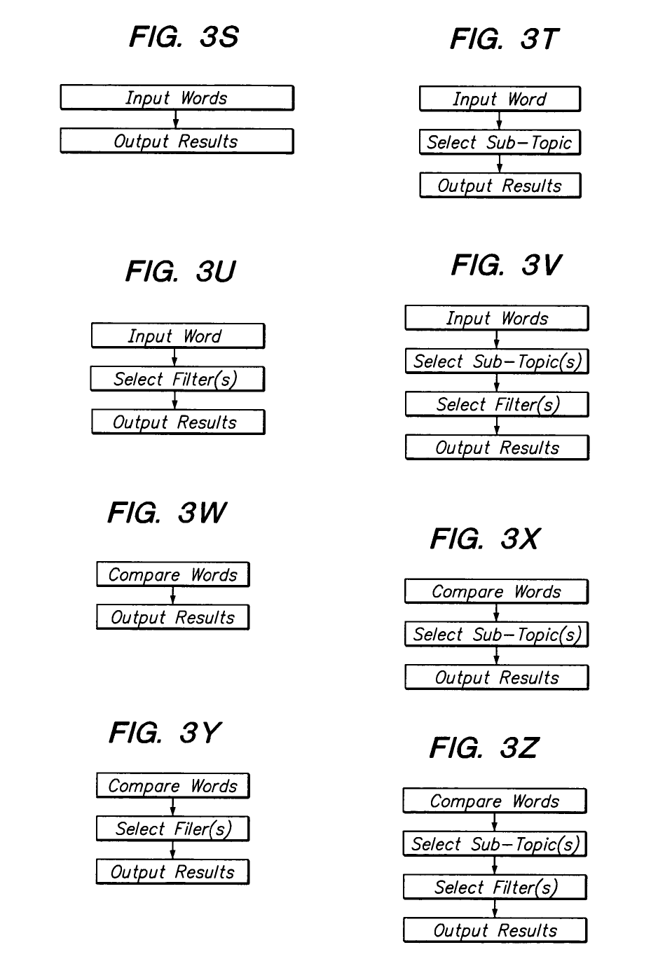

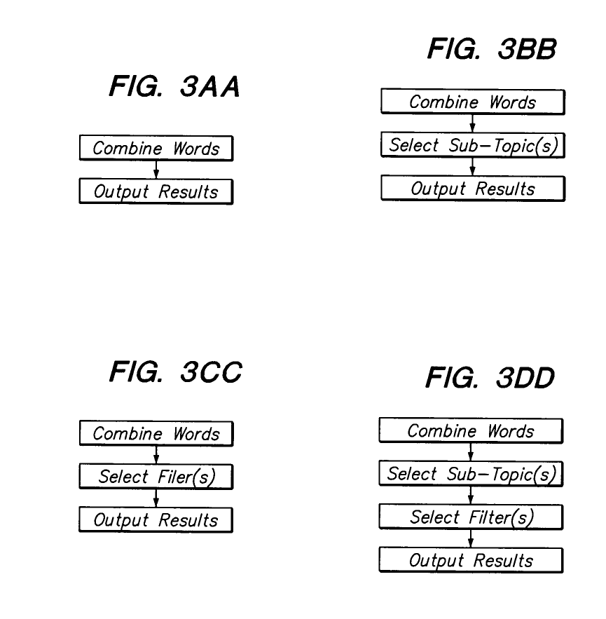

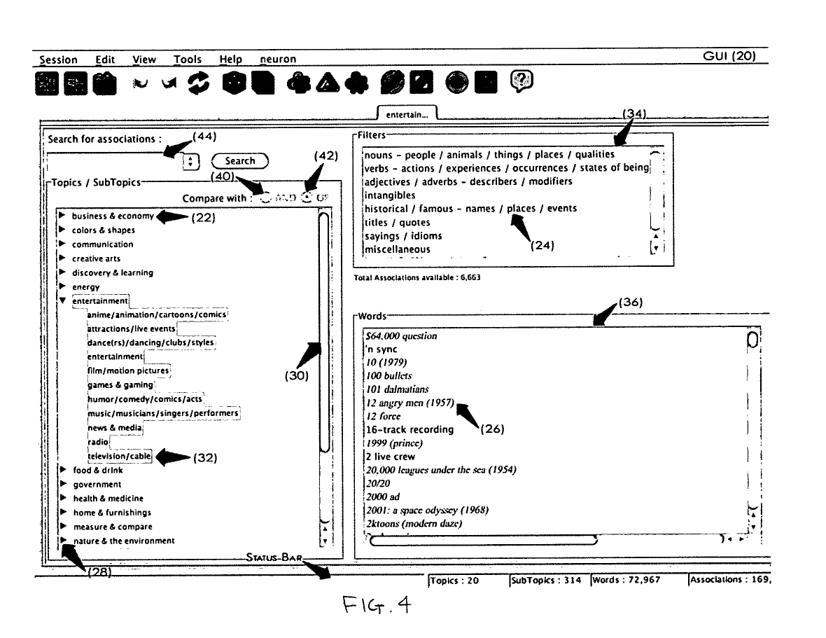

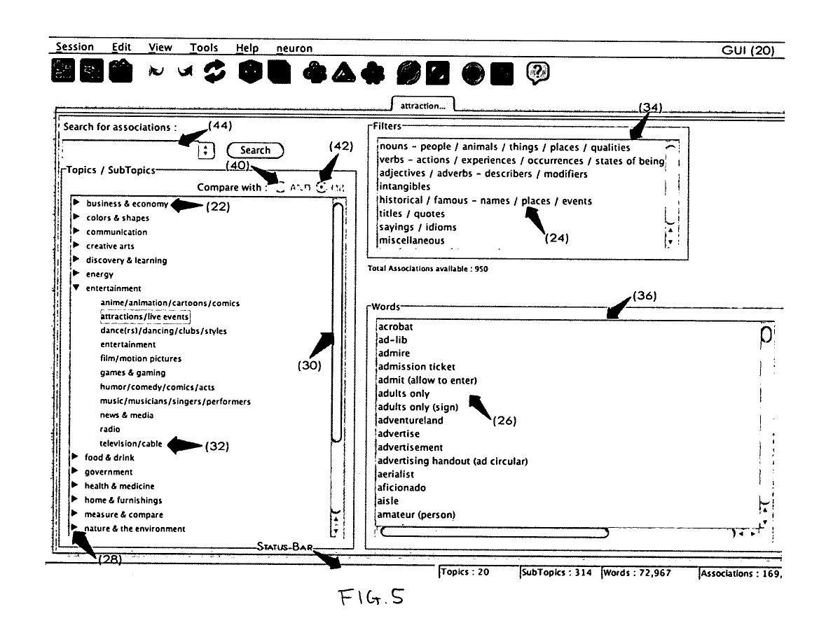

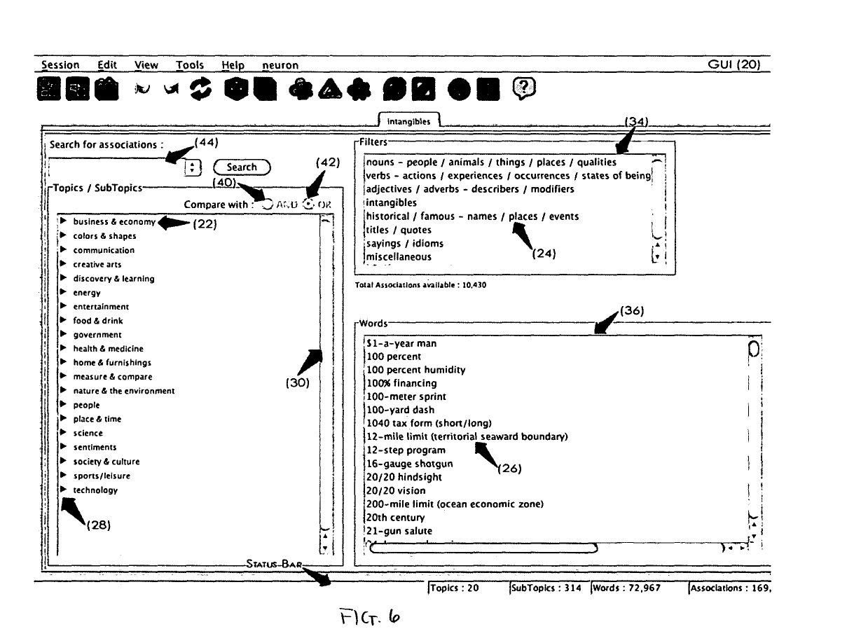

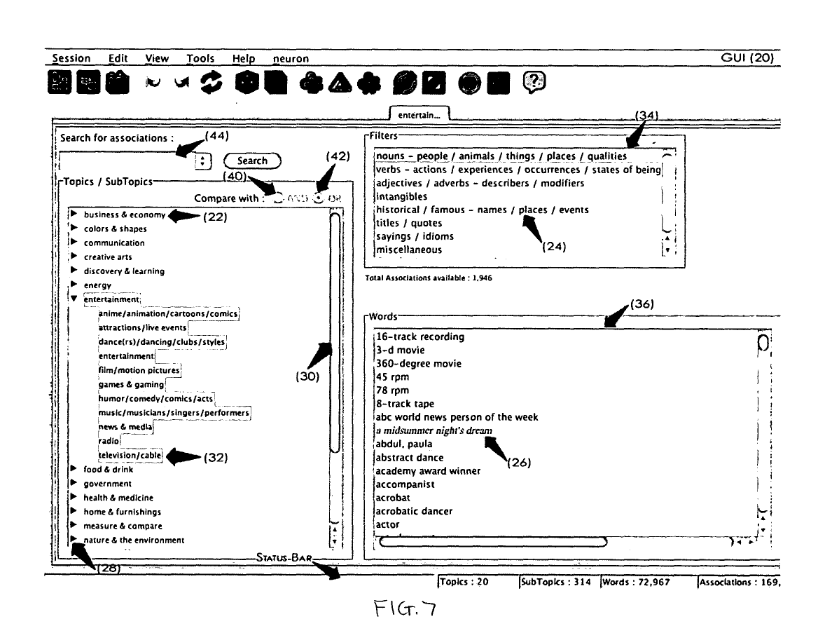

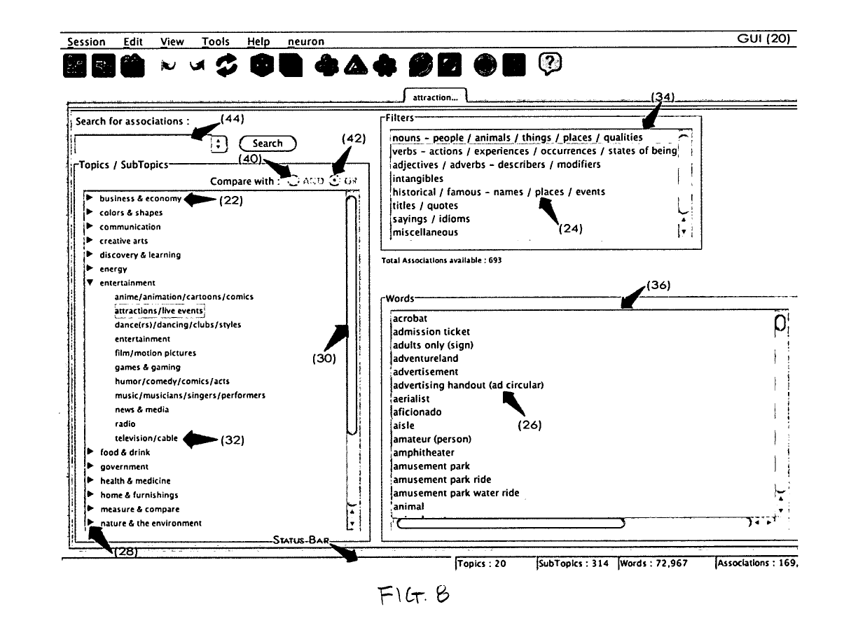

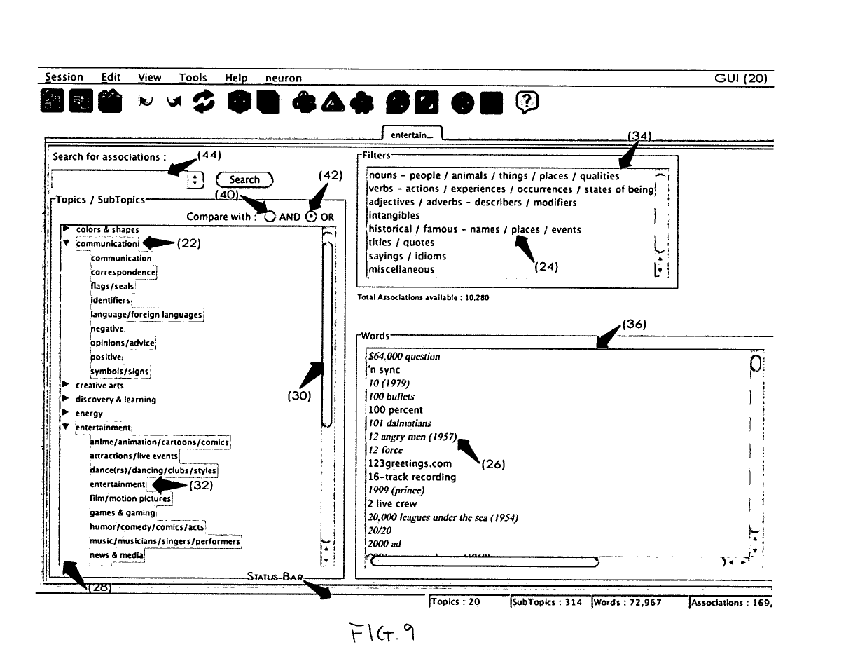

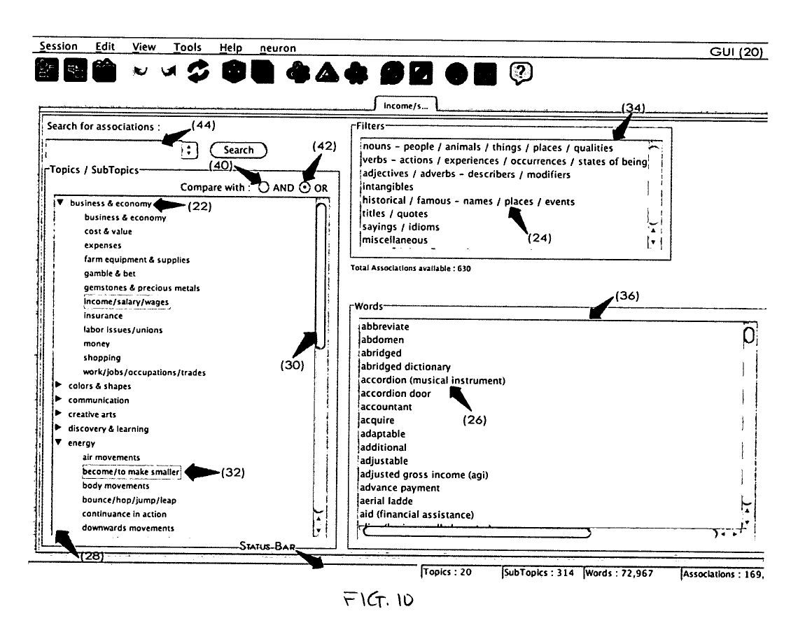

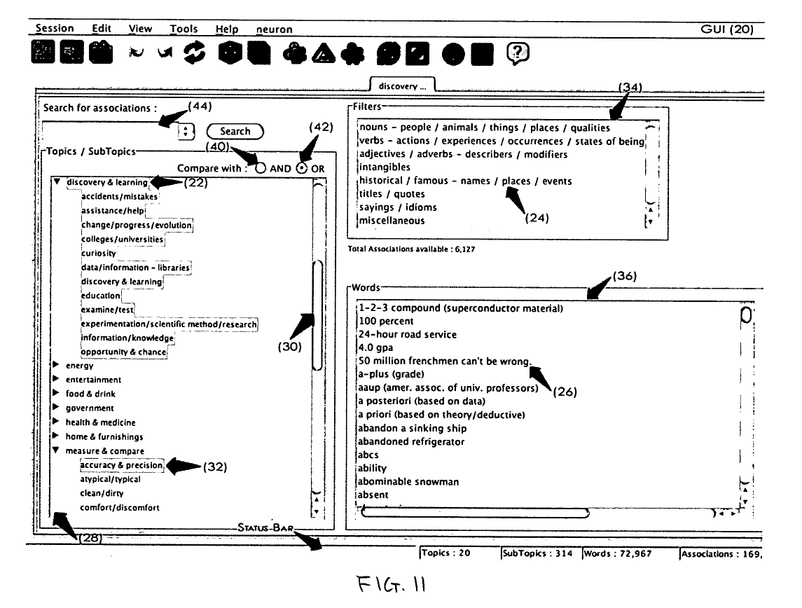

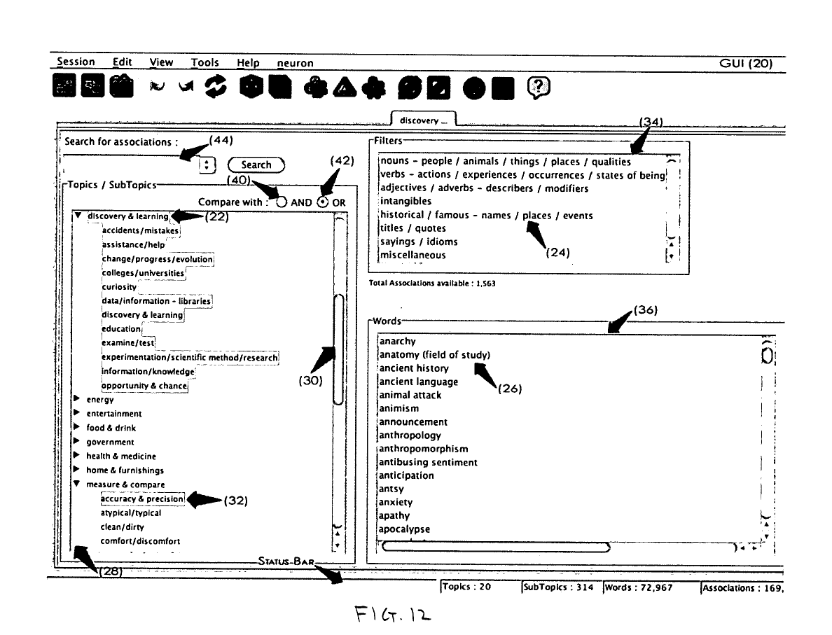

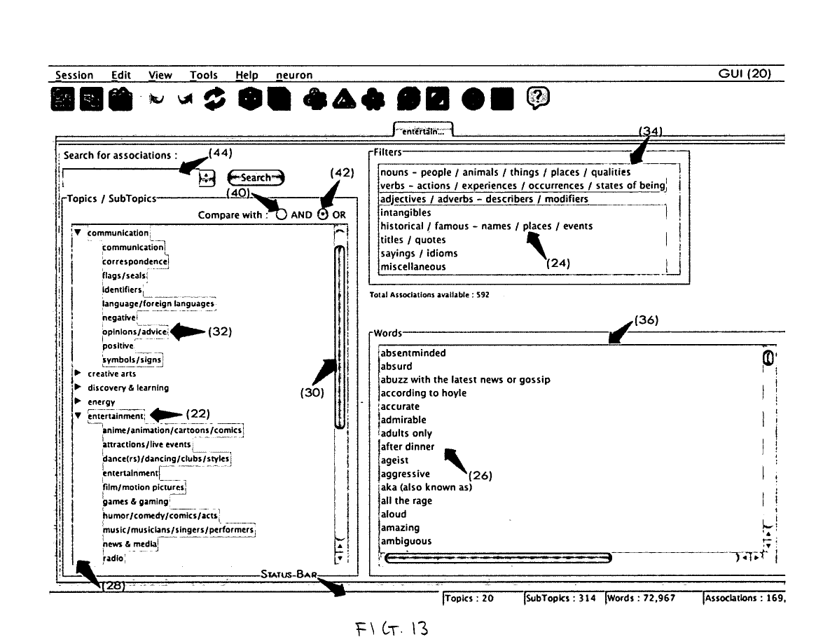

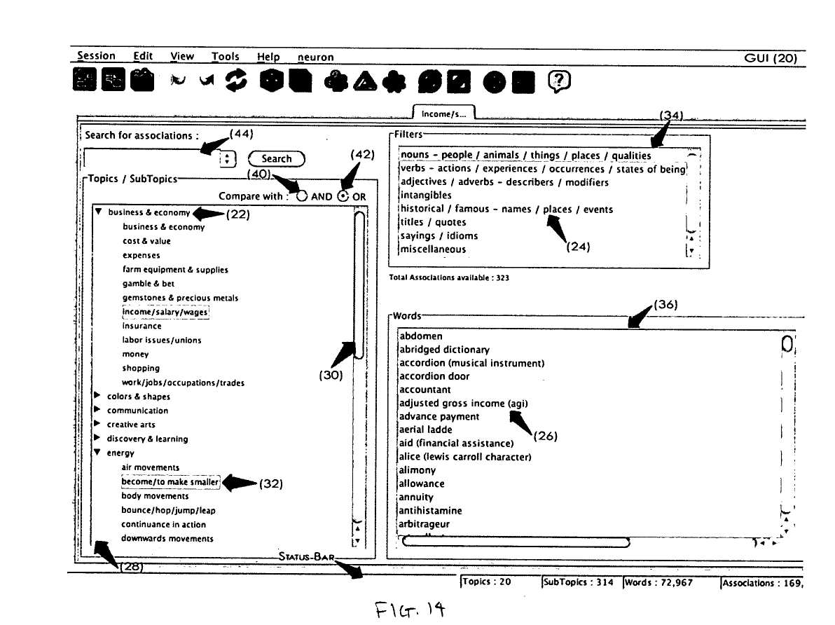

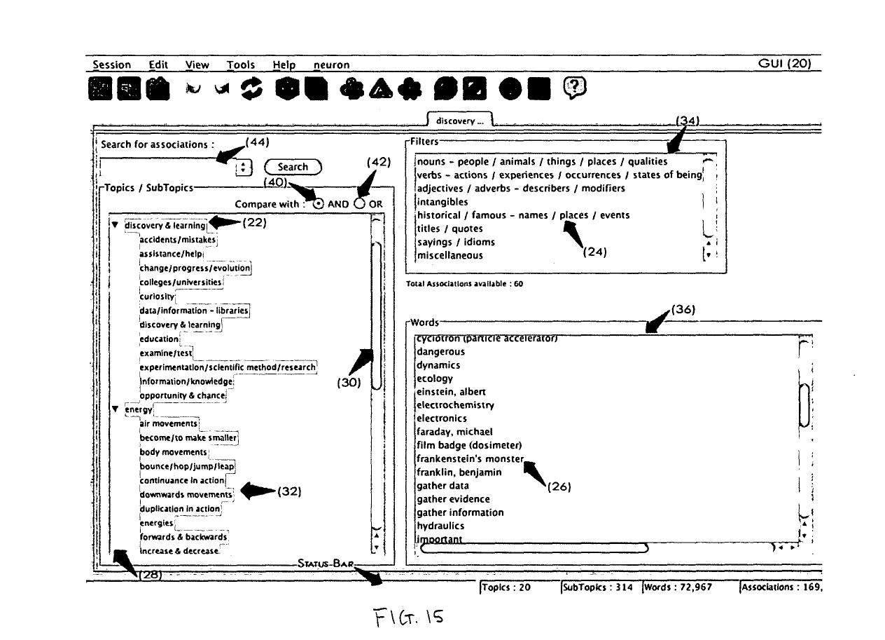

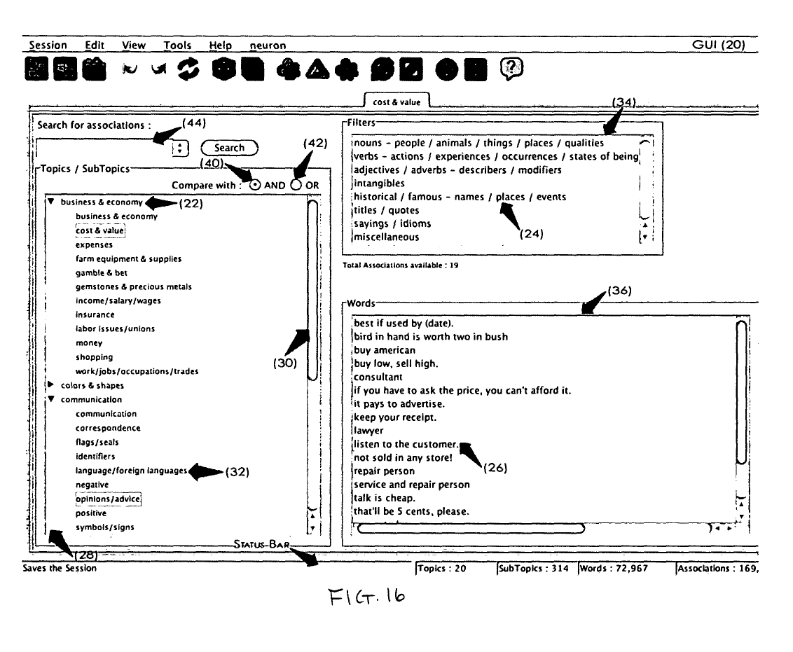

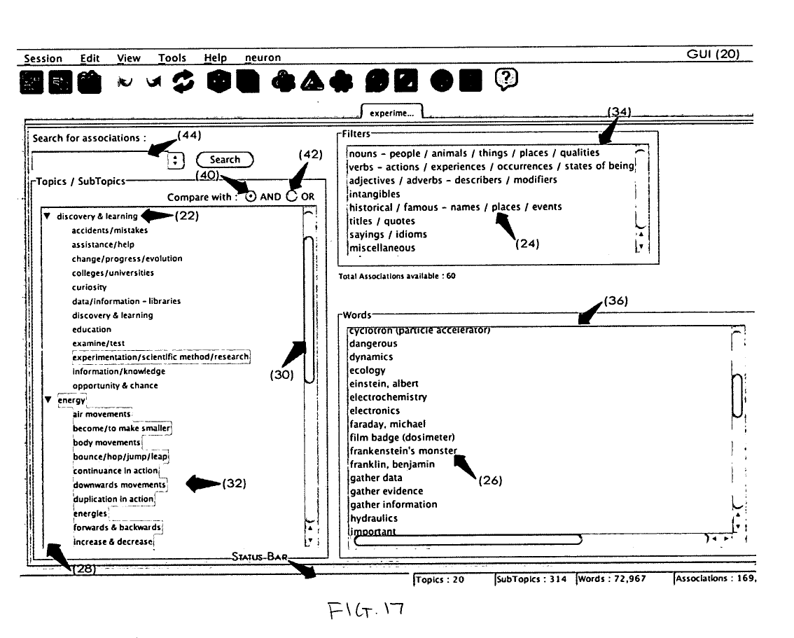

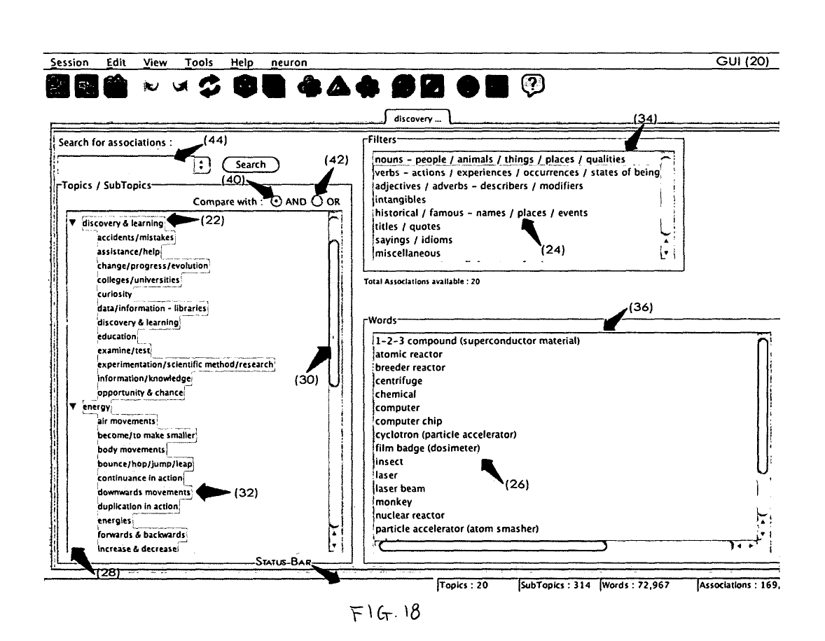

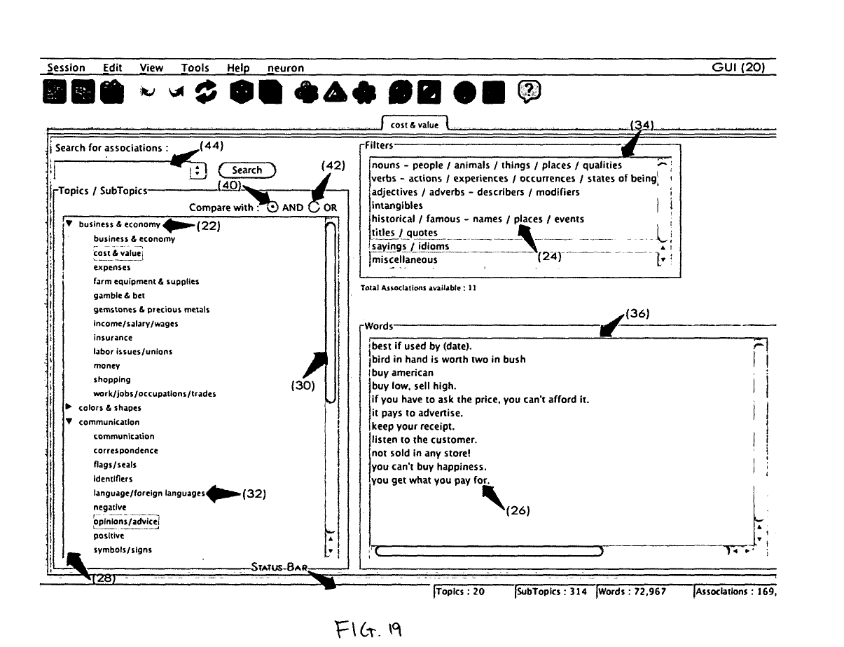

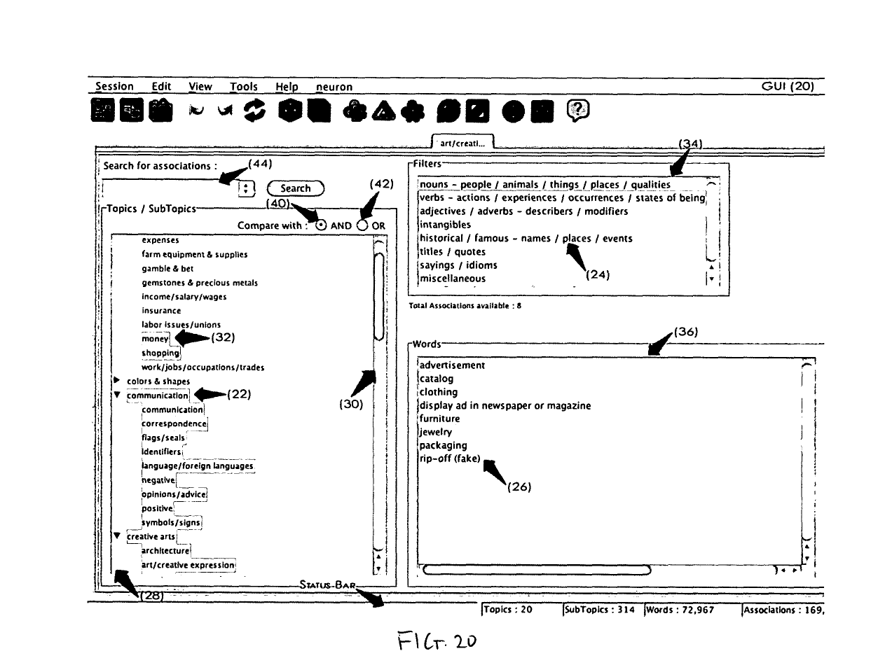

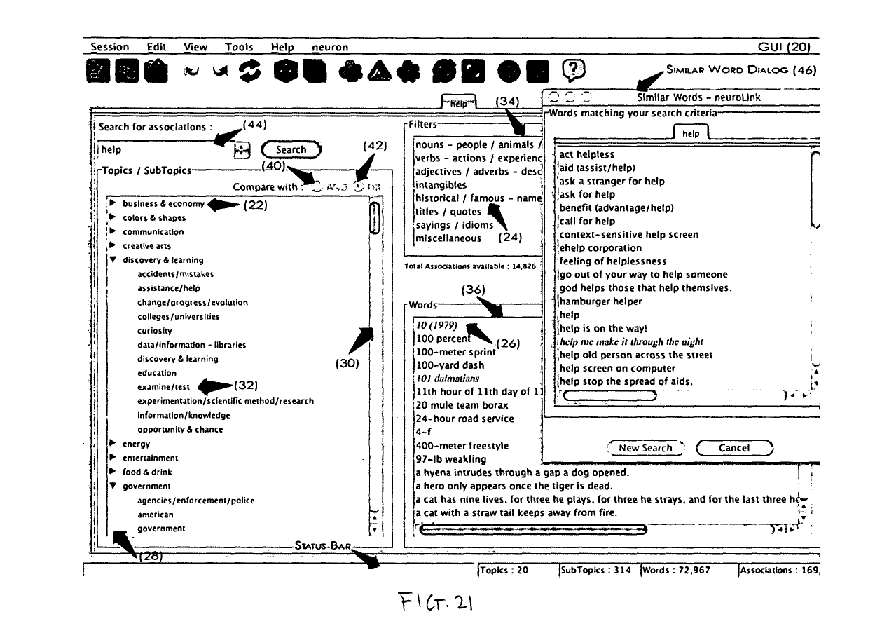

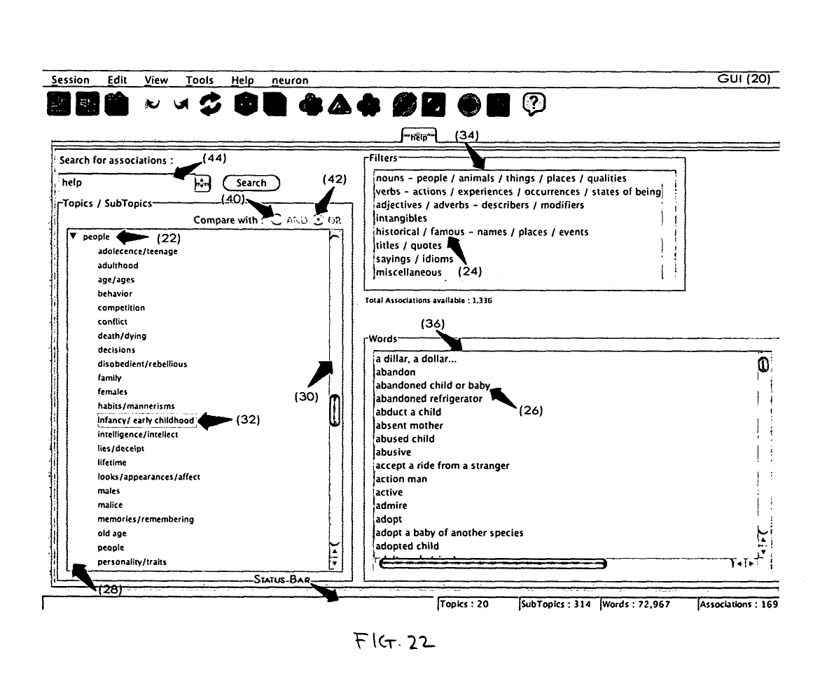

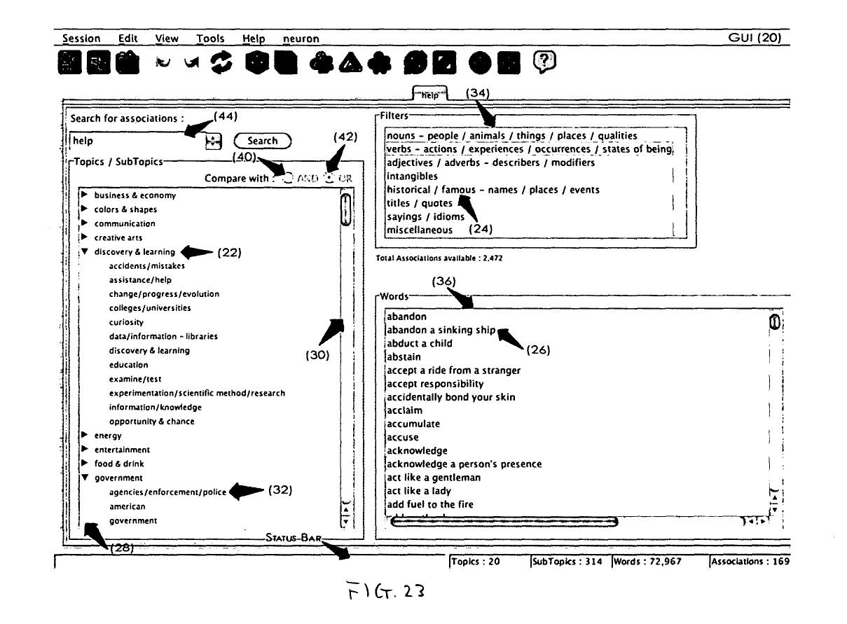

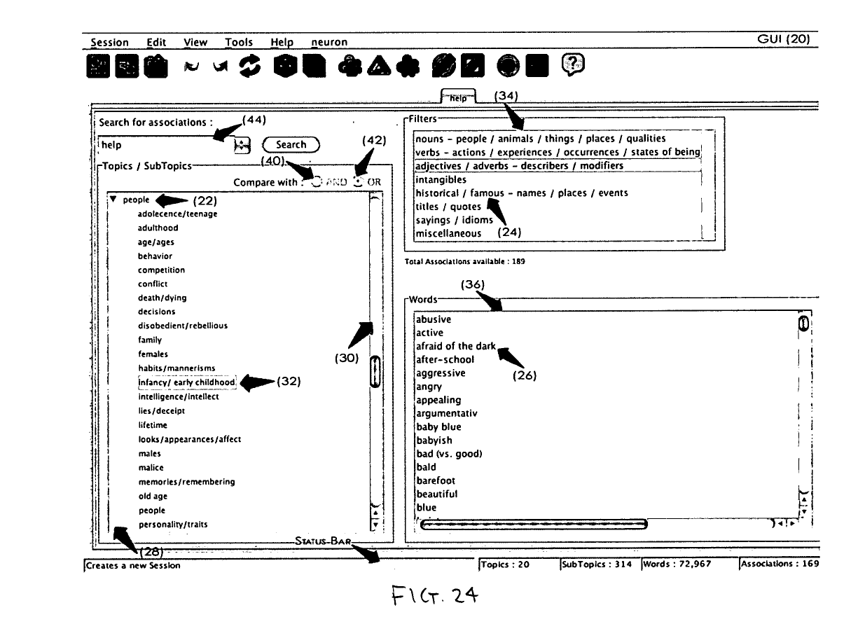

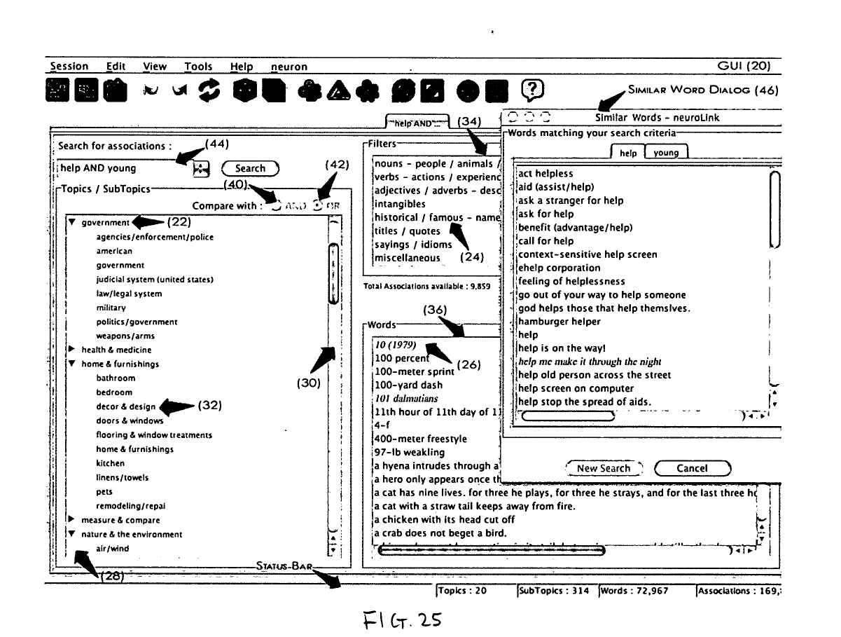

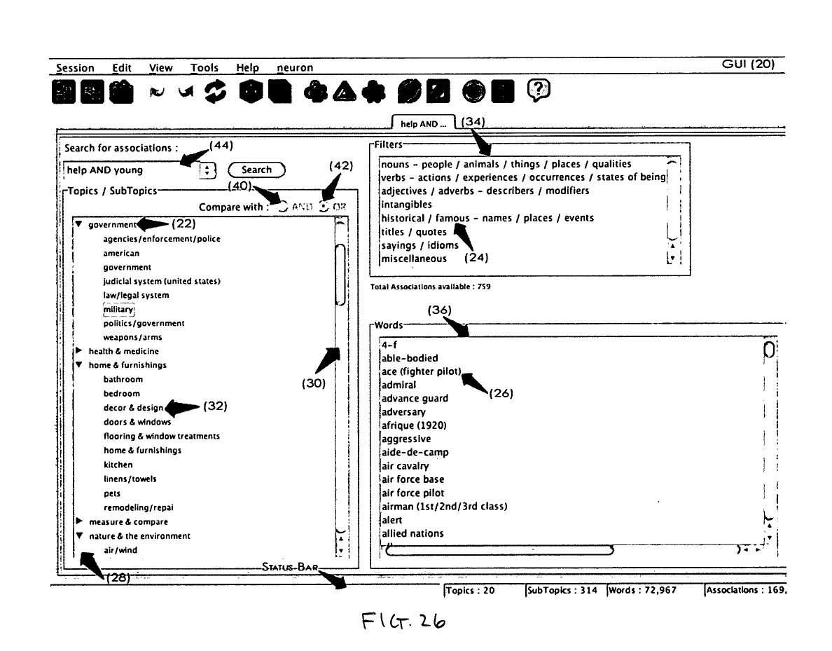

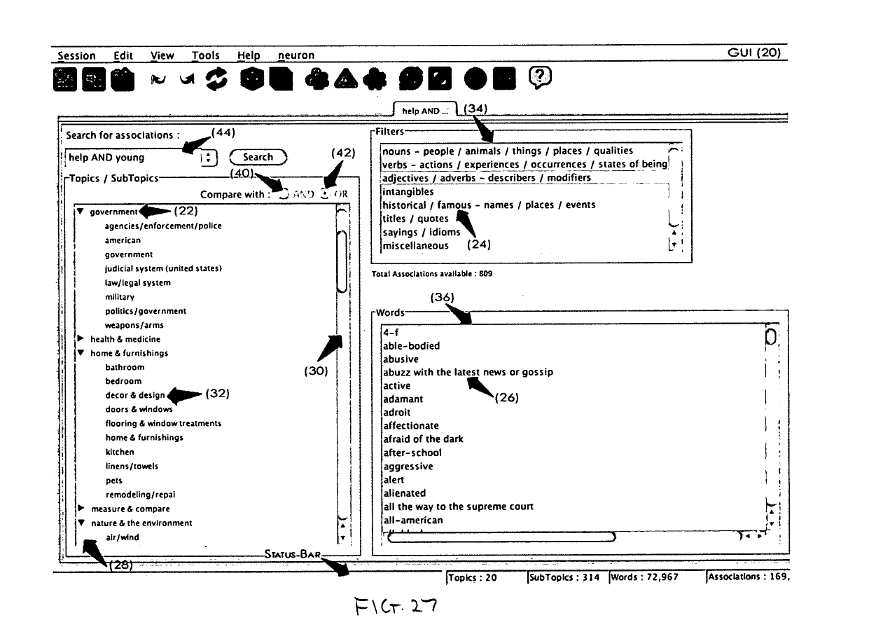

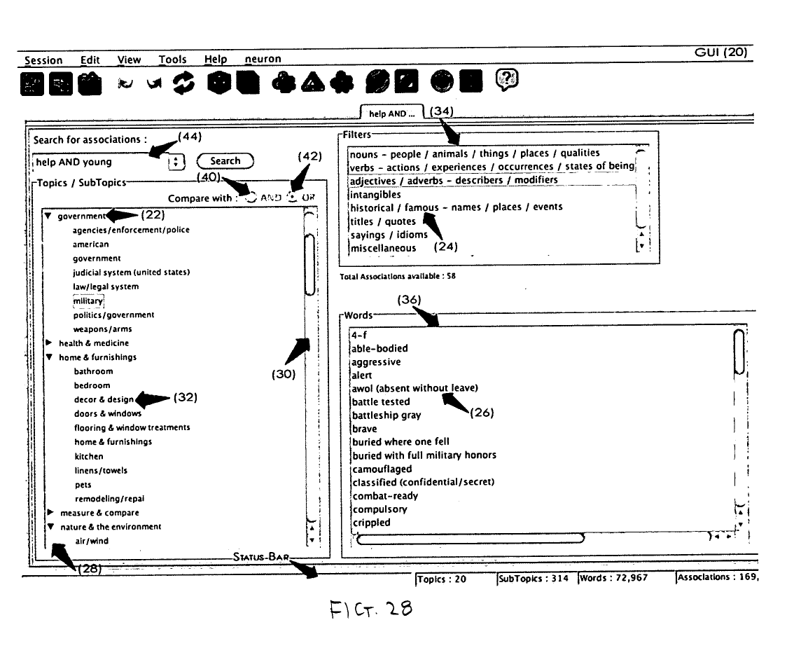

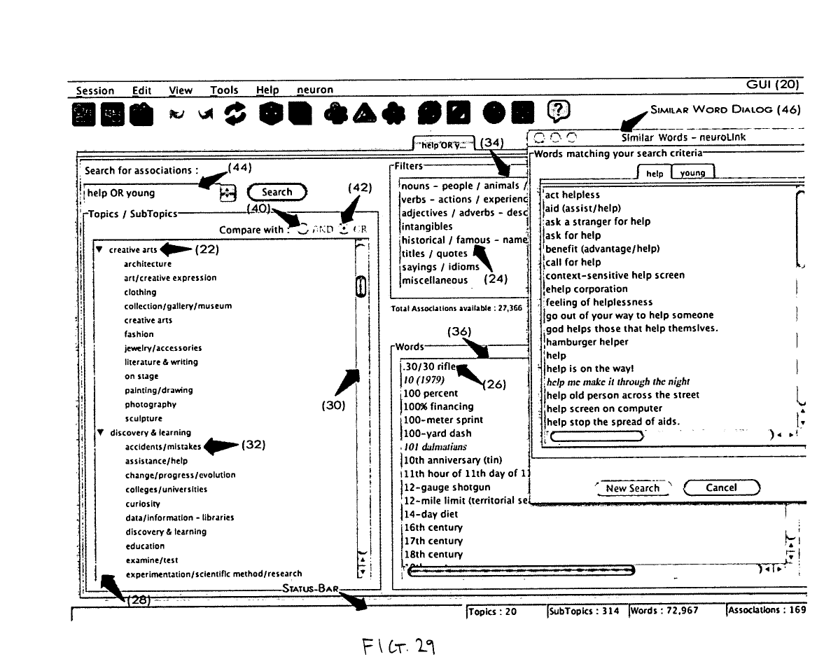

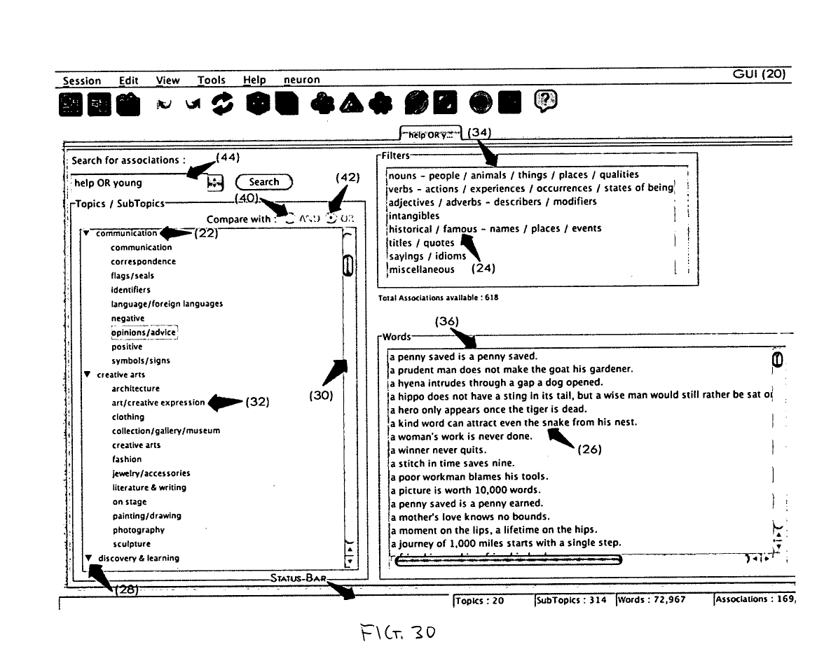

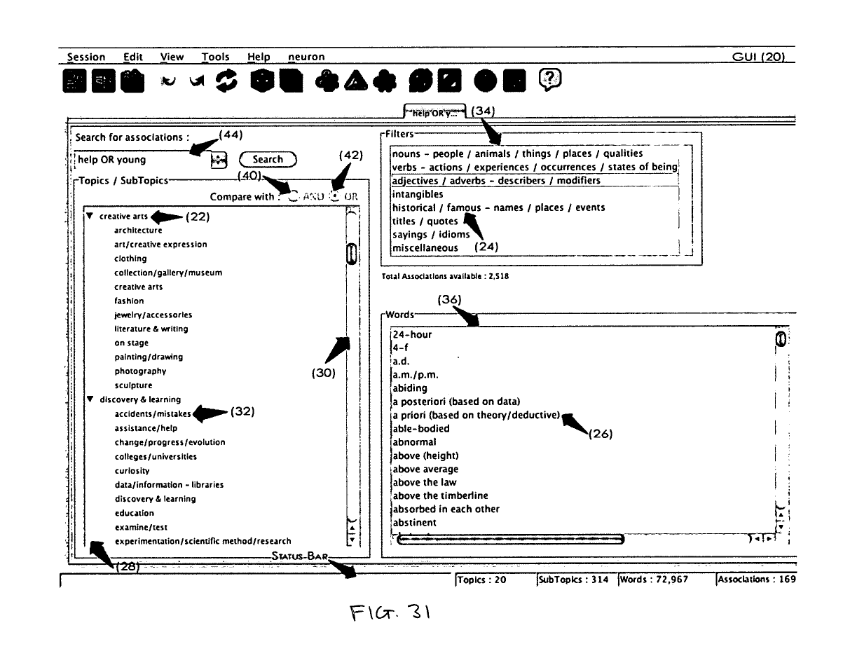

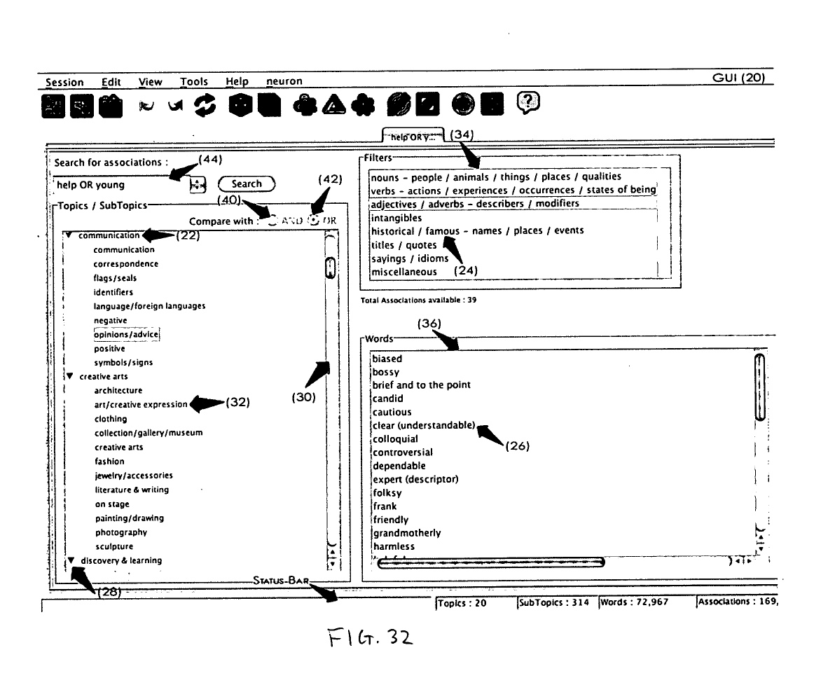

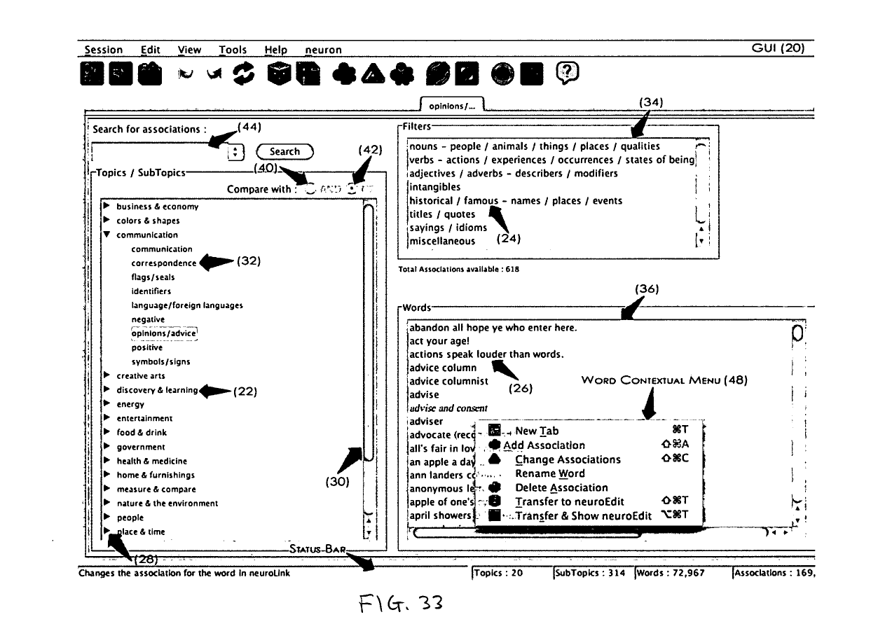

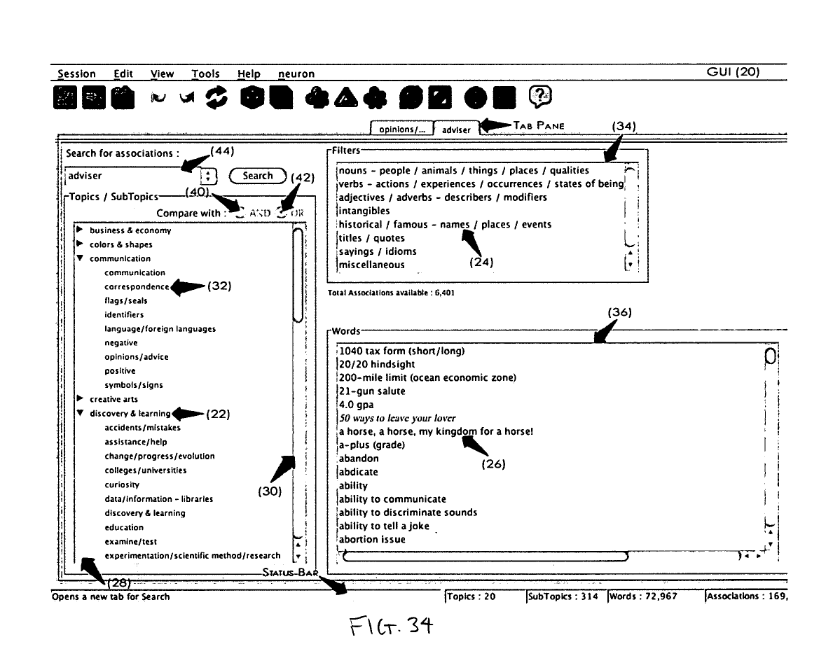

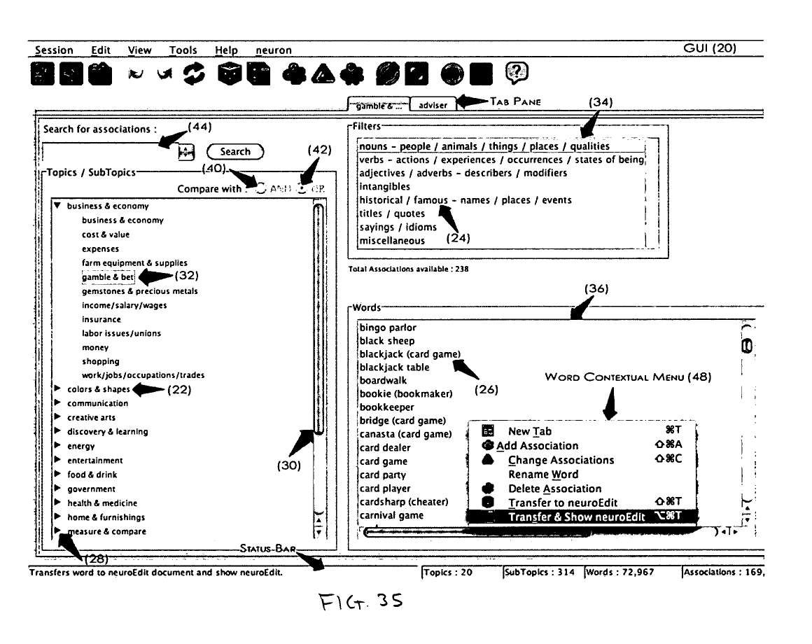

Other features of the graphical user interface 20 of the invention will be described in more detail with respect to particular functionality of the invention. Reference will be made to a variety of the features as summarized in FIG. 3(a)-(dd).

As one aspect of the invention, a user may select a topic 22, as illustrated in FIG. 3(a) and FIG. 4. A user may utilize a cursor or other selector to select a displayed topic 22. In accordance with the invention, as set forth in FIG. 3(a), when a particular topic 22 is selected from the tree box 28, all words, phrases or concepts 26 which are associated, or linked, to that topic 22 are provided. In one embodiment, this comprises displaying the associated or linked words, phrases or concepts 26 in the words list box 36. For example, as illustrated in FIG. 4, selection upon the exemplary topic “entertainment” causes associated or linked words such as the exemplary words “$64,000 Question” and “n sync” to be displayed in the words list box 36.

The words, phrases or concepts 26 may be displayed in a variety of fashions. In the preferred embodiment, as illustrated, words, phrases or concepts 26 are displayed in alphabetical order. A scroll bar or similar feature may be provided to alter the view of the data displayed in the list box.

Similarly, if a user selects a sub-topic 32, as set forth in FIG. 3(b), then only those words, phrases or concepts 26 associated with the selected sub-topic 32 are displayed. It will be appreciated that, generally, the number of words, phrases or concepts 26 displayed in association with a particular sub-topic 32 are generally less than the number of words, phrases or concepts 26 that are displayed when only the topic 22, which contains the sub-topic 32, is displayed. In other words, a sub-set of words, phrases or concepts 26 applicable to the sub-topic 32, is selected. For example, as illustrated in FIG. 5, selection of the exemplary sub-topic “attractions/live events” causes associated or linked words such as exemplary words “acrobat” and “ad-lib” to be displayed in the words list box 36.

In one embodiment, referring to FIG. 3(c), a user may select a filter 24. An example of this method will be described with reference to FIG. 6. When a user selects a filter 24, all words, phrases or concepts 26 which are associated with or identified by the selected filter 24 are displayed. As illustrated, a user has selected the filter “intangibles.”

In another embodiment, as illustrated in FIG. 3(d), a user may select both a topic 22 and a filter 24. An example of this method will be described with reference to FIG. 7. As illustrated, a user may select a topic 22, such as the exemplary topic “entertainment.” As illustrated in FIG. 4, such a selection alone would cause the display of all words, phrases or concepts 26 which are associated or linked to that topic.

The user may also select one or more filters 24, such as the exemplary filter “nouns.” As illustrated in FIG. 7, the further selection of a filter 24 causes the display of words, phrases or concepts 26 both associated, or linked, with the selected topic and associated, or linked, with the “nouns” filter.

As illustrated in FIG. 3(e), a user may select both a sub-topic 32 and one or more filters 24. An example of this method will be described with reference to FIG. 8. As illustrated, a user may select a sub-topic 32, such as the exemplary sub-topic “attractions/live events.” As illustrated in FIG. 5, such a selection alone would cause the display of all words, phrases or concepts 26 which are associated or linked to that topic.

The user may also select one or more filters 24, such as the exemplary filter “nouns.” As illustrated in FIG. 8, the further selection of a filter 24 causes the display of words, phrases or concepts 26 both associated, or linked, with the selected sub-topic and associated, or linked with the “nouns” filter.

As illustrated in FIG. 3(f), a user may also select a filter 24 and one or more sub-topics 32. In this embodiment, all words, phrases or concepts 26 which are associated with the selected filter and the select sub-topic 32 are displayed or generated.

A user may also generate only the set of words, phrases or concepts 26 common to selected multiple topics 22 and/or sub-topics 32, or the set of words, phrases or concepts included in any of the selected multiple topics 22 and/or sub-topics 32. The results of such selections may also be filtered to provide filtered results.

As set forth in FIG. 3(g), a user may select multiple topics 22 for combination. In one embodiment, the user may utilize a “compare with ‘OR’” radio button selection 42. The selection of this function and a plurality of (i.e. two or more) topics 22 causes a list of words, phrases or concepts 26 to be displayed. The displayed words, phrases or concepts 26 comprise those words, phrases or concepts associated with, or found in any of, the selected topics 22. FIG. 9 illustrates an example of this method, in which an output is provided based upon the selected topics “communication” and “entertainment.”

As set forth in FIG. 3(h), a user may similarly select multiple sub-topics 32. FIG. 10 illustrates an example of this method, in which an output is provided based upon the selected sub-topics “income/salary/wages” and “become/to make smaller.”

Referring to FIG. 3(i) and FIG. 11, a user may select both a topic 22 and sub-topic 32. The selected sub-topic 32 is preferably one which does not fall under the selected topic 22. This method outputs words, phrases or concepts 26 which are associated with both the select topic 22 and sub-topic 32. As illustrated in FIG. 11, a user has selected the topic 22 “discovery & learning” and the sub-topic 32 “accuracy & precision.”

Referring to FIG. 3(j) and FIG. 12, a user may filter the results of a selected topic 22 and sub-topic 32 combination. In particular, a user may select a topic 22, sub-topic 32 and one or more filters 24, such as the “intangibles” filter which is shown selected in FIG. 12.

As illustrated in FIG. 3(k), a user may filter the results of multiple selected topics 22 by selecting one or more filters 24. FIG. 13 illustrates one example of such a method. In this example, the “adjectives/adverbs” filter 24 has been applied to the multiple selected topics “communication” and “entertainment.”

As illustrated in FIG. 3(l), a user may similarly filter the results of multiple selected sub-topics 32 by selecting one or more filters 24. FIG. 14 illustrates on example of such a method. In this example, the “noun” filter 24 has been applied to the multiple selected sub-topics “income/salary/wages” and “become/to make smaller.”

In one embodiment, multiple topics 22 or sub-topics 32 may be compared. In one embodiment, this is accomplished with a “compare with ‘AND’” radio button selection 40 is provided on the graphical user interface 20. The selection of this function and at least two topics 22 and/or sub-topics 32 causes a list of words, phrases or concepts 26 to be displayed. The displayed words, phrases or concepts 26 comprise those words, phrases or concepts common to (i.e. only those words, phrases or concepts found in all) the selected topics 22 and/or sub-topics 32.

Referring to FIG. 3(m), in one embodiment a user may compare multiple topics 22. FIG. 15 illustrates one example of such a method. In this example, the user has selected the “compare with ‘AND’” function and the multiple topics “discovery & learning” and “energy.”

Similarly, referring to FIG. 3(n), a user may compare multiple sub-topics 32. FIG. 16 illustrates one example of such a method. In this example, the user has selected the “compare with ‘AND’” function and the multiple sub-topics “cost & value” and “opinions/advice.”

Referring to FIG. 3(o) and FIG. 17, a user may also compare topics 22 and subtopics 32. In this configuration, a user select at least one topic 22 and at least one sub-topic 32 with the “AND” function. All words, phrases or concepts 26 common to the selected topic and sub-topic are generated.

Referring to FIG. 3(p), a user may filter the resultant comparison of multiple topics 22 by selecting one or more filters 24. FIG. 18 illustrates one example of the invention where a user has used the “nouns” filter 24 to filter the results of the compared topics “discovery & learning” and “energy.”

Referring to FIGS. 3(q) and FIG. 19, a user may filter the resultant comparison of multiple sub-topics 32 by selecting one or more filters 24. FIG. 19 illustrates one example of this method.

Referring to FIG. 3(r), a user may filter the resultant comparison of a topic 22 and a sub-topic 32 by selecting one more filters 24. FIG. 20 illustrates one example of this method.

Preferably, one embodiment of the invention is a search method. As illustrated in FIG. 1, the graphical user interface 20 includes a search text box 44. The search text box 44 accepts input of one or more terms, such as words. In accordance with a method of the invention, upon input of a term or terms, two actions are preferably triggered.

First, as illustrated in FIG. 3(s), it is determined if the term or terms are one or more of the pre-existing words, phrases or concepts 26, and if so, an output is provided comprising the topic(s) 22 and/or sub-topics 32 with which the term(s) is/are associated. Second, any related or similar words or terms are provided.

FIG. 21 illustrates one example of this method. As illustrated, the user has input the word “help” into the search text box 44. Words, phrases or concepts 26 which are associated with that word are displayed. In one embodiment, any topics 22 and/or sub-topics 32 with which the term is associated are also displayed, such as by highlighting.

In addition, related or similar terms are displayed in a separate word dialog 46. In one embodiment, the related or similar terms are all terms which include the input term or word. Other criteria may be used for generating related or similar terms.

As will be described in more detail below, in this configuration, by inputting a term or terms, a user is provided with information regarding topics 22 or sub-topics 32 to which the term(s) is associated. In addition, the user is provided with information regarding related words, phrases or concepts which the user may find pertinent or clarifying.

In one embodiment, a user is permitted to select related terms. For example, referring to FIG. 21, a user may select one of the related terms from the similar word dialog. In the example illustrated, the user might select the term “act helpless.” Upon such a selection, related words to that newly selected word or term is displayed. In one embodiment, the results are displayed in yet another dialog or window.

In one embodiment, as illustrated in FIG. 3(t), a user may input a word and select a sub-topic 32 to generate results. One example of this method is illustrated in FIG. 22. As illustrated, a user has input the term “help” into the search text box 44 and has selected the sub-topic “infancy/early childhood.” Associated words, phrases or concepts 26 associated with both the word and the selected sub-topic 32 are displayed to the user.

Referring to FIG. 3(u), a user may filter the result or output associated with an input word by selecting one or more filters 24. FIG. 23 illustrates one example of this method, in which the results have been filtered with the “verbs” filter.

As illustrated in FIG. 3(v), a user may filter the results of an input word and a selected sub-topic 32 by selecting one or more filters 24. FIG. 24 illustrates an example of such a method. As illustrated, the user has applied the “adjectives” filter to the search term “help” and sub-topic “infancy/early childhood.”

In one embodiment, a user may search by comparing multiple terms or words. In one embodiment, as illustrated in FIG. 3(w), a user may search or input multiple terms or words for comparison. By “comparison” it is meant that the results are applicable to each of the input terms or words.

FIG. 25 illustrates one embodiment of such a method. As illustrated, the user has input the terms “help” and “young” into the search text box 44. The user has utilized the “AND” connector between the input words to signify the desire to search for both terms. Other means may be provided for triggering this function, such as by use of the word “and.” As a result of this input, topics 22 and/or sub-topics 32 with which the terms or words are associated are displayed (such as by highlighting), as is a list of associated words, phrases or concepts 26. In addition, the similar word dialog 46 has been displayed, this dialog including one window or pane providing a listing of similar words, phrases or concepts associated with the input word “help,” and another window or pane providing a listing or similar words, phrases or concepts associated with the input word “young.”

As illustrated in FIG. 3(x), a user may further limit or screen the results of a multiple word or term comparison search by selecting one or more sub-topics 32. FIG. 26 illustrates such an embodiment of this method of the invention.

Referring to FIG. 3(y), a user may filter the result of a multiple word comparison search by selecting one or more filters 24. FIG. 27 illustrates one example of this method.

As further illustrated in FIG. 3(z), a user may still further filter the results of a multiple word comparison search which has been limited by selection of a sub-topic 34 by selecting one or more filters 24. FIG. 28 illustrates such an embodiment of this method of the invention.

In one embodiment of the invention, as illustrated in FIG. 3(aa), a user may generate results associated with any of a plurality of input terms using a “combine” function. FIG. 29 illustrates one example of such a method. As illustrated, the user has input the terms “help” and “young” into the search text box 44 with the “OR” connector. This signifies that the user wishes to obtain information regarding associations with either of the input terms (not just associations which are common to both terms). This function is referred to as a “combine” or “combination” function. Once again, this input preferably also results in the display of a similar word dialog which provides similar word information for the input words (in this case, panes or tabs for the words “help” and “young”).

As illustrated in FIG. 3(bb), a user may further limit or screen the results of a multiple word or term combination search by selecting one or more sub-topics 32. FIG. 30 illustrates such an embodiment of this method of the invention.

Referring to FIG. 3(cc), a user may filter the result of combined words by selecting one or more filters 34. FIG. 31 illustrates one example of this method.

As further illustrated in FIG. 3(dd), a user may filter the results of a search of combined words and a select sub-topic 34 by selecting one or more filters 24. FIG. 32 illustrates such an embodiment of this method of the invention.

Various features and benefits of the above-referenced aspects of the invention will now be described. In accordance with the invention, a user is provided with a plurality of topics 22 and sub-topics 32 from which to choose. A user may desire to learn, for example, of words or phrases which are applicable to a particular topic in which they are interested. The user may simply locate and select the desired topic or sub-topic, after which words, phrases or concepts which are associated or linked with the selected topic or sub-topic are provided. As described, a user may further narrow or refine these results. For example, a user may require nouns associated or linked with the topic “animals/pets.” The user may simply select the “noun” filter 24 to obtain only the words, phrases or concepts that are nouns (thus screening out information the user does not desire, other parts of speech such as verbs, titles or the like).

As described, a user may also combine topics 22 and/or sub-topics 32 in a variety of manners to generate unique results. For example, a user may be interested in concepts relating to the use of animals in space. The user may select the topics “animals/pets” and “astronomy/outer space.” By selecting the “OR” feature, the user is provided with all terms associated or linked to those topics (i.e. a “combine” function). Alternatively, the user may select the “AND” feature, and be provided with all terms commonly associated or linked with both or all the sub-topics of those topics, thus screening out terms which do not relate to both the desired topics/sub-topics (i.e. a “compare” function).

A user may select only a filter 24 in order to view or obtain a list of words, phrases or concepts 26 to which that filter is applicable. For example, the user may be interested in “theories” and thus selects the applicable “intangibles” filter to generate a list of words, phrases or concepts which are categorized as such.

A user may also obtain information regarding associated words and topics and/or sub-topics by inputting one or more terms in the search box. For example, a user may be interested in information associated with the term “collie.” By inputting this term, the user may learn that the term is associated with or linked with the topic “animals/pets.” The user may then search by that particular topic to obtain associated information. The user is preferably also provided with related or similar terms. For example, the term “collie” may bring up the related or similar term “border collie” in the related word dialog or window providing further information for use by the user.

One aspect of the invention is the ability to start with a broad concept and obtain useful detailed information regarding that concept. For example, a user may desire to write an article about animals. The user may select that topic and obtain a plethora of specific words, phrases and/or concepts associated with the topic. A user may also start with narrow or specific information and obtain broad information. For example, a user may start with a single word. Using the word, the user may obtain broad topic and sub-topic information. Of course, the user may use one or more filters to explore within those results.

In the configuration described and illustrated, a particular advantage of the invention is the interrelated “linking” or associating of topics/sub-topics, words and filters. Because all of these parameters are bi-directionally associated, a user can move freely from any of the parameters to any other of the parameters. As described, this may comprise moving “up” from a particular word to a broad topic, or “down” from a broad topic to a particular word. A user may also move “across” from one word to a related or similar word.

By associating or linking these units or pieces of information, a myriad of results may be obtained. For example, a single word may be linked to more than one topic or sub-topic. This has distinct advantages over a hierarchical type configuration where a word may be located under only a single topic. For example, if a user searches by topic or sub-topic in accordance with the present invention, the user may obtain results including the word without having to have selected a single particular topic where the word was classified. As one example, the word “blue” may be associated with the topic “colors” and the topic “bodies of water.” If the user is searching for words regarding the topic “bodies of water,” the user encounters the word “blue.” From there, the user might use the term “blue” to reach the topics “colors” or to obtain related words, such as “royal blue.” In the present invention, another advantage of the association or linking is that a user can locate a plurality of topics using a single word. For example, if the user in the above example searched the word “blue,” the user would be provided with both associated topics “colors” and “bodies of water.” This type of linking more closely mirrors the linking of terms, concepts and other information in the brain, and is thus more effective as a memory recall aid or brain-storming tool.

A user can also chain results together. For example, a user may start with a particular word. Upon input, the user may be provided with a list of related words in the related word dialog. The user may determine that a particular word or phrase from this list is more applicable. By selecting that word or phrase, the user obtains topic/sub-topic associations for this similar or related word, adding to the results for the originally input word. This information may trigger the recall of information or inspire new thoughts, all of which the user may find beneficial to their desired goal. Upon selection of a particular topic, the user may be provided with other words the user finds interesting. This process of searching and displaying associated results may continue endlessly, in similar fashion to the method of memory retrieval in the brain, resulting in effective memory recall and idea generation as well as improving the user's memory.

In accordance with one embodiment of the invention, the tool or system may include an editor application. The editor application may comprise a word-processing type application that includes a text window for use by a user. In accordance with the invention, the user may transfer results, such as particular words, phrases or concepts, from the main module to the editor module.

For example, a user may wish to write an article regarding a particular topic. The user may utilize the editor application to input text information. When the user needs memory recall or idea generation assistance, the user may open the application described above. The user may then obtain results of various queries. The result of the search may, as indicated, comprise a particular word, phrase or concept. The user may select that word, phrase or concept for importation to the editor, such as for input directly into the text where the word, phrase or concept is to be located.

One aspect of the invention is the ability to “customize” the system. Because each user has different memories and thus stores different information in different means, each user may desire to customize the system and method so that it is most effective for their use.

In one embodiment of the invention, a user can perform various customizations with respect to the particular words, phrases or concepts 26. In another embodiment of the invention, a user can perform various customizations with respect to the particular topics 22 and sub-topics 32.

Referring to FIG. 33, in accordance with one embodiment of the invention, a user can perform one or more of the following functions with respect to the words, phrases and/or concepts 26: conduct a new search; add an association; change an association; delete an association; or transfer words between application modules. A word contextual menu 48 may be displayed to the user, such as by selection from a main menu or by performing a “right-click” within the words list box 36. The user may then select one of the available options from the menu.

Referring to FIG. 34, as one aspect of the invention, individual searches are preferably shown in separate tab panes. As illustrated, the most recently accessed tab pane is preferably displayed on top. Each tab pane is preferably provided with a tab so that it may be identified.

In one method of the invention, a user may transfer one or more words. As illustrated in FIG. 35, this function may be initiated by using the “transfer word” function. In one embodiment, the word may be transferred to a new window or document area. FIG. 35 illustrates an example where a user has selected the word “bridge” and selected the “transfer word” function. As illustrated, the word has been placed within a new document area for use by the user.

In one embodiment, a word may be transferred to an editor or a word processor type application or module. Once transferred to that module, the user may input other words and thoughts or utilize other word-processing type functions which are well known to those of skill in the art. FIG. 36 illustrates a window or graphical user interface for use in implementing such functions.

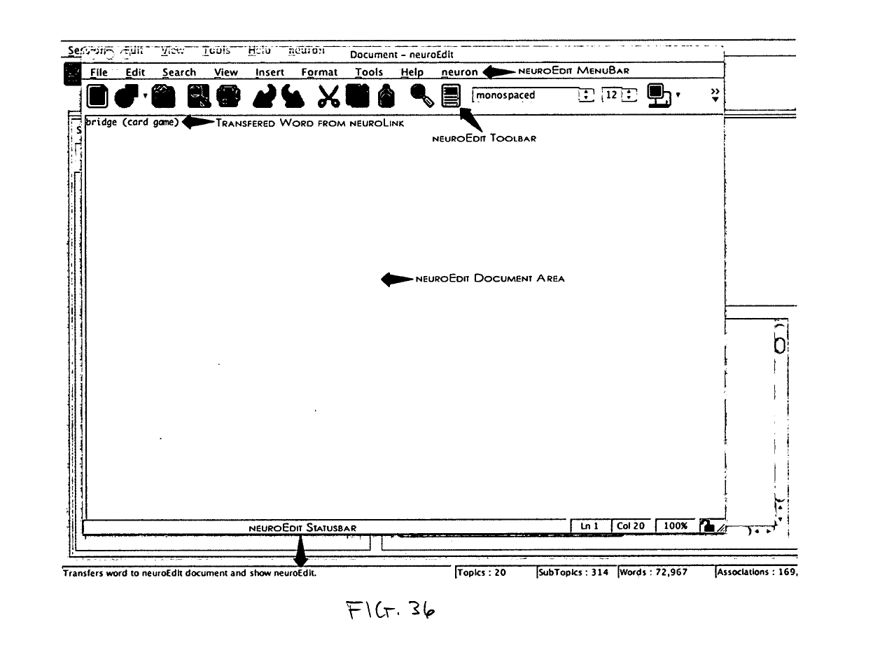

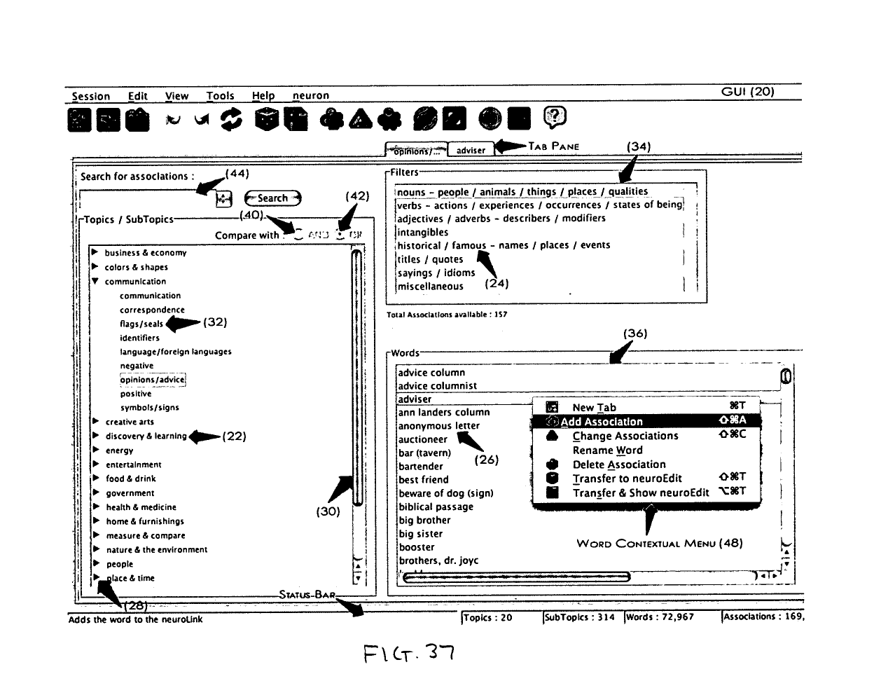

Referring to FIG. 37, in one embodiment a user may select an “add association” function. As illustrated in FIG. 38, selection of this function may first cause the display of an “add and associate” window or dialog, which window shows words, phrases or concepts 26 which are available for transfer, as well as those which the user has selected for transfer. As illustrated, this window may include a search box, allowing the user to input information for searching.

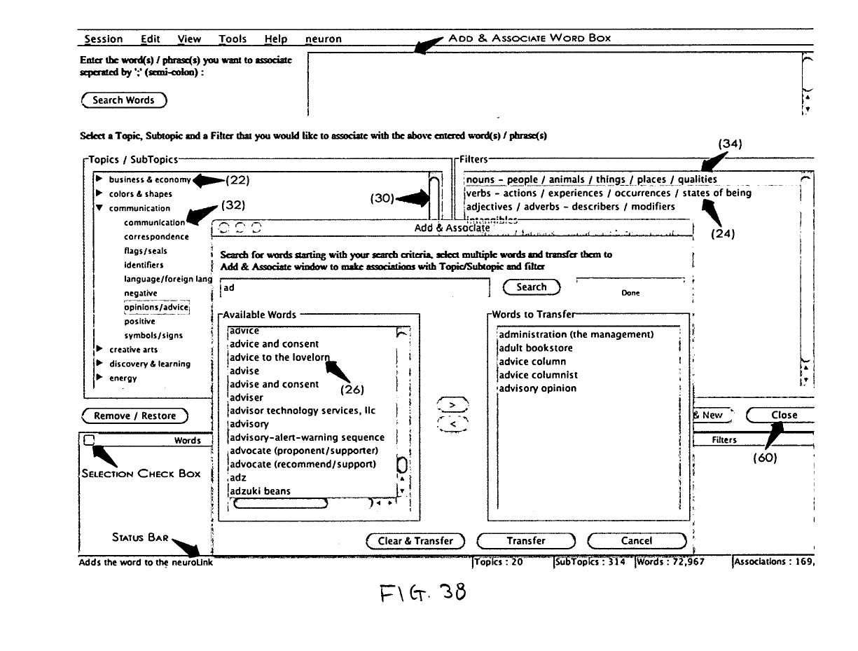

Referring to FIG. 39, once the user has selected words, phrases or concepts 26 for transfer, in one embodiment, a new dialog or window is displayed. As illustrated, this dialog includes a list of available topics 22 and sub-topics 32, as well as a list of filters 24. As also illustrated, this window preferably includes an “add and associate” word box which lists the word or words which the user has selected.

The user is permitted to select one or more topics 22, sub-topics 32 and filters 24 with which the word(s) is to be associated. In one embodiment a tracking table 52 is provided which displays the user's designated associations. The user is permitted to delete designated associations, such as with an undo button 54. The user may also save the associations using a “save” button 56, or save the association and initiate a new association with a “save and new” button 58. The user may end the “add association” session by selecting a “close” button 60. Selection of the “close” button 60 preferably closes the add association dialog and returns the user to the main window.

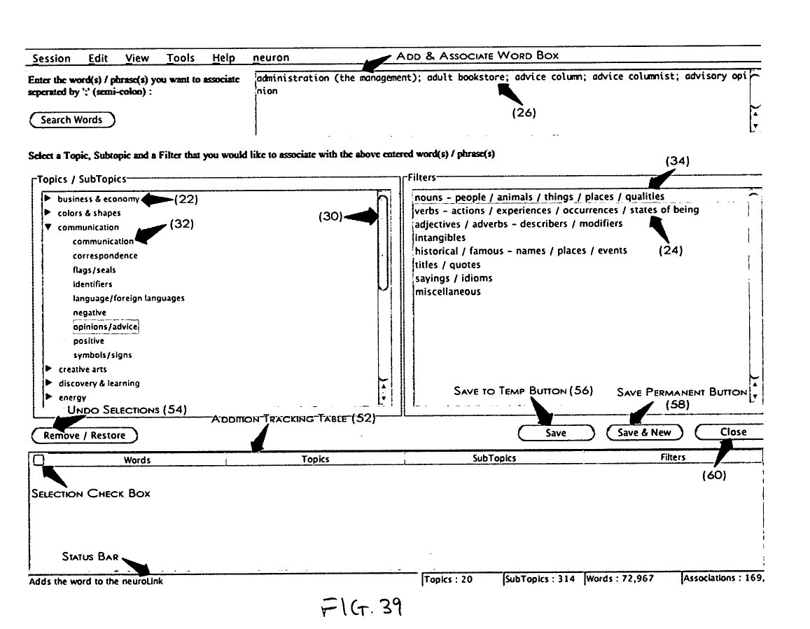

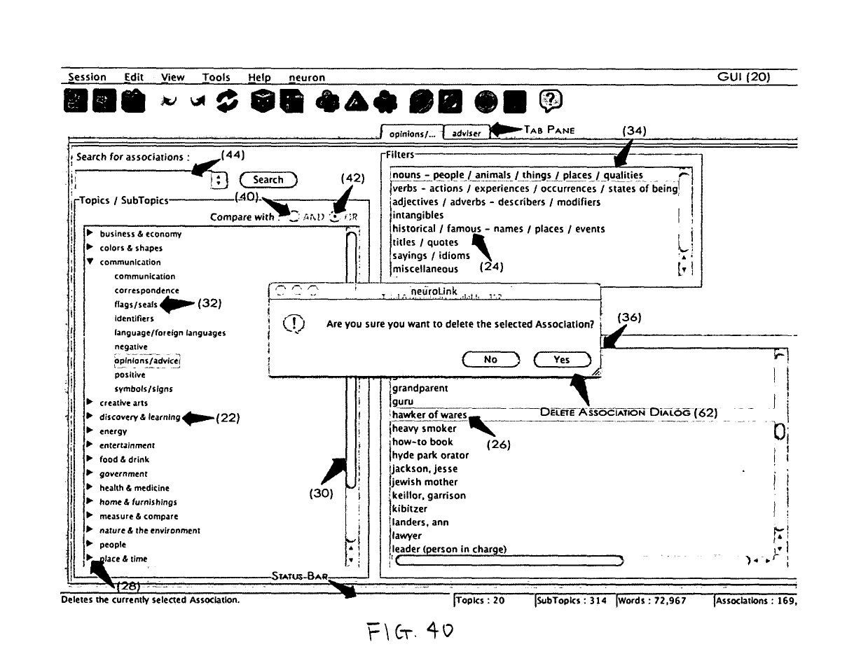

Referring to FIG. 40, in one embodiment a user may select a “delete” association function, such as from the menu or the word contextual menu. As illustrated in FIG. 40, in one embodiment this causes the display of a delete association confirm dialog or window 62. In the example illustrated, the user has been requested to confirm the user's desire to delete the association of the word “hawker of wares” with the sub-topic “opinions/advice.”

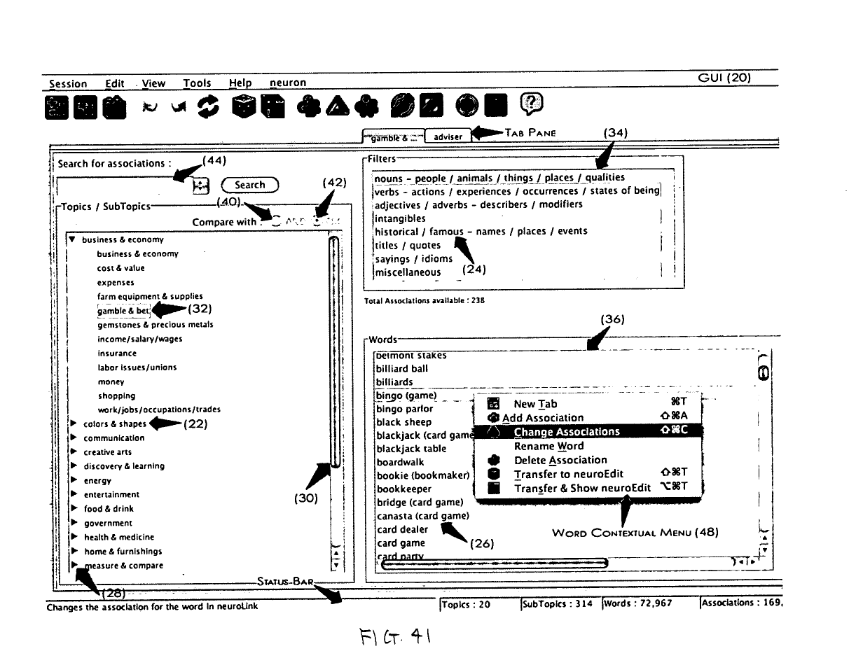

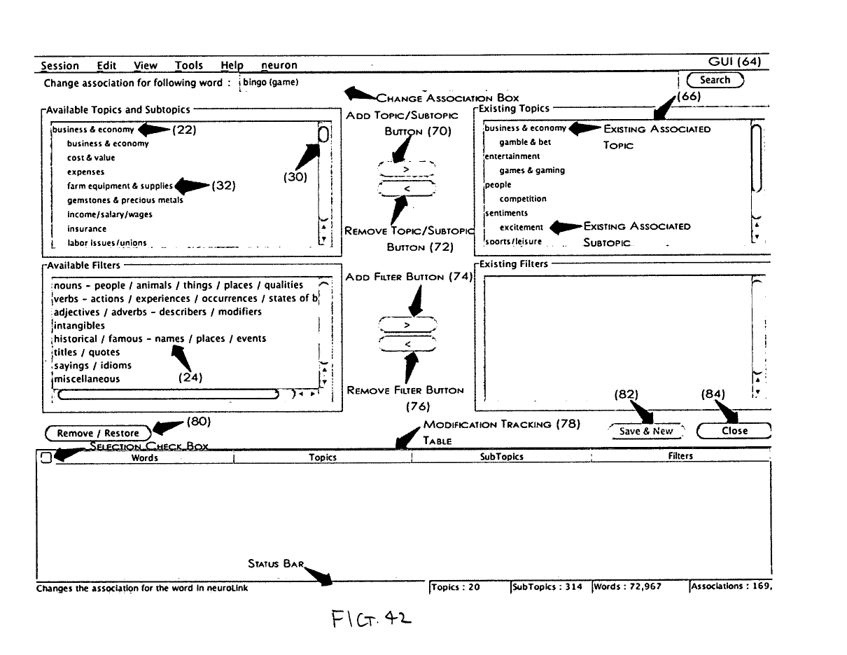

Referring to FIG. 41, in one embodiment a user may select a “change” association function. As illustrated in FIG. 42, in one embodiment this causes the display of a “change” association dialog or window 64. This dialog 64 displays an existing topics and sub-topics list 66 which includes all existing topics and sub-topics which are associated with the word which the user wishes to change. The dialog 64 also includes a list of all possible topics 22 and sub-topics 32, as well as all possible filters 24.

Add topic/sub-topic and remove topic/sub-topic buttons 70,72 are provided, as are add filter and remove filter buttons 74,76. In addition, the dialog 64 includes a tracking table 78 to display user changes.

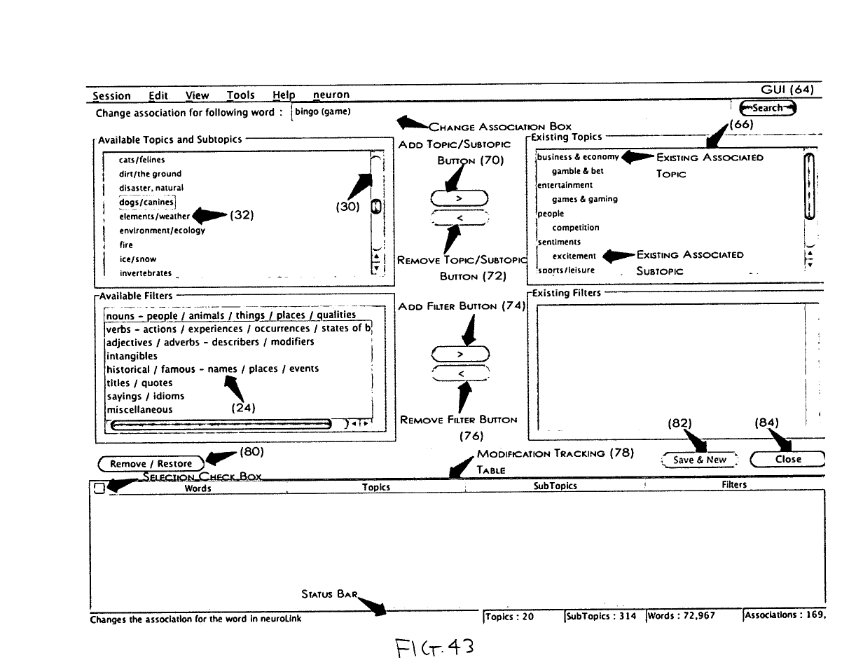

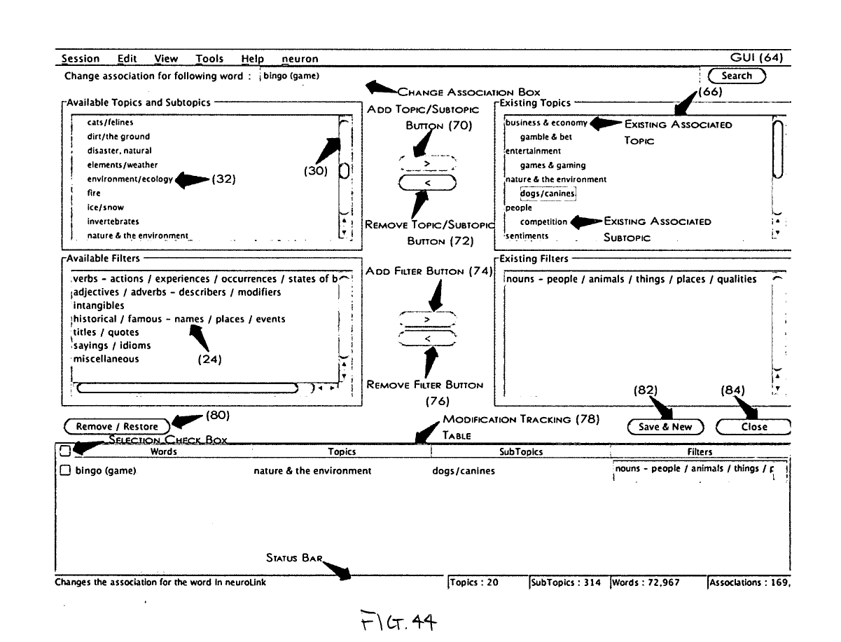

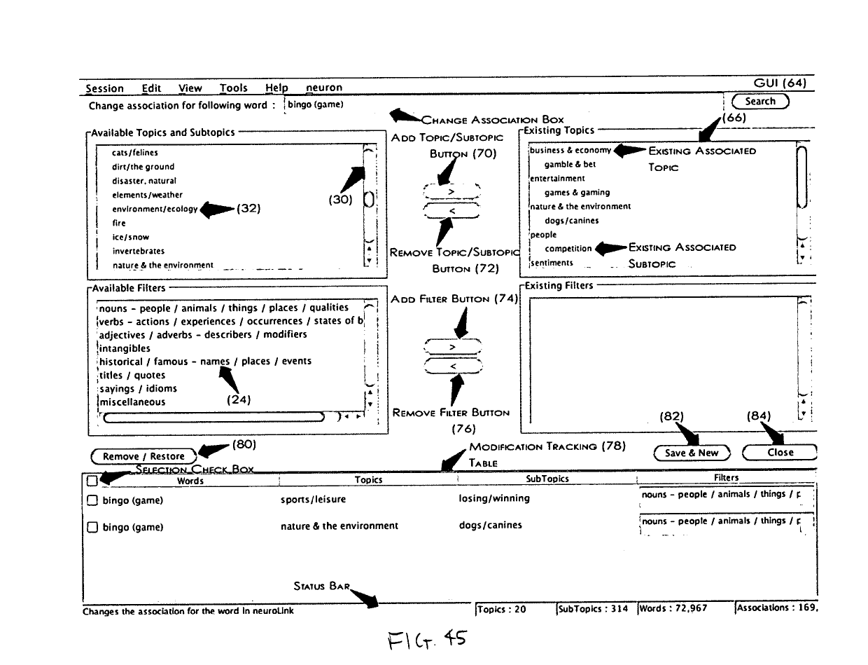

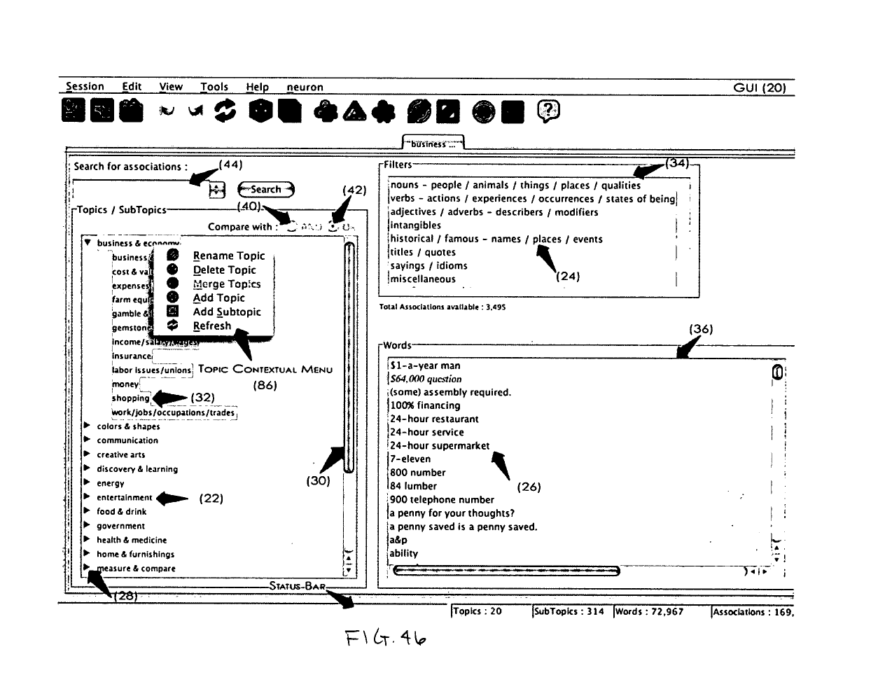

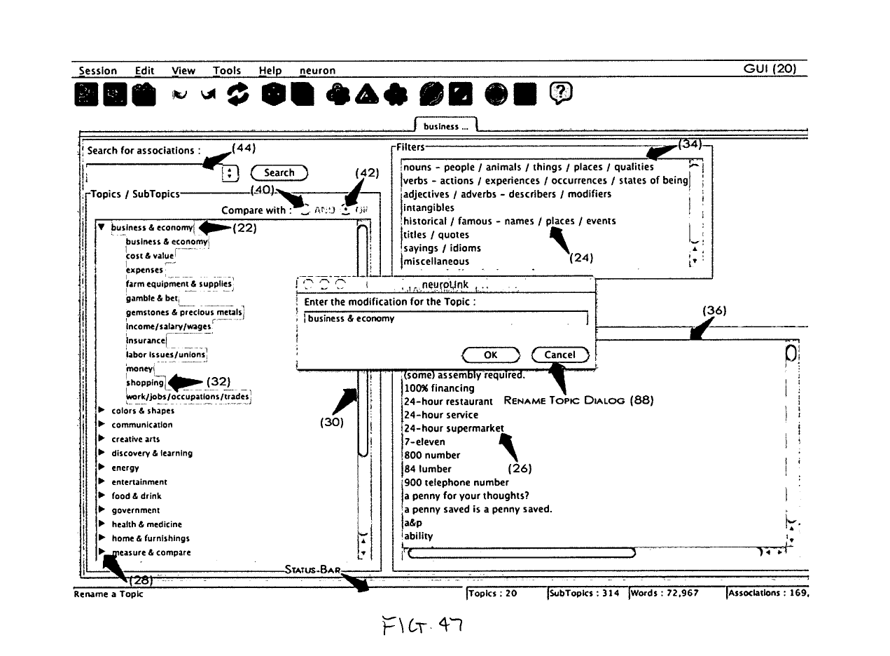

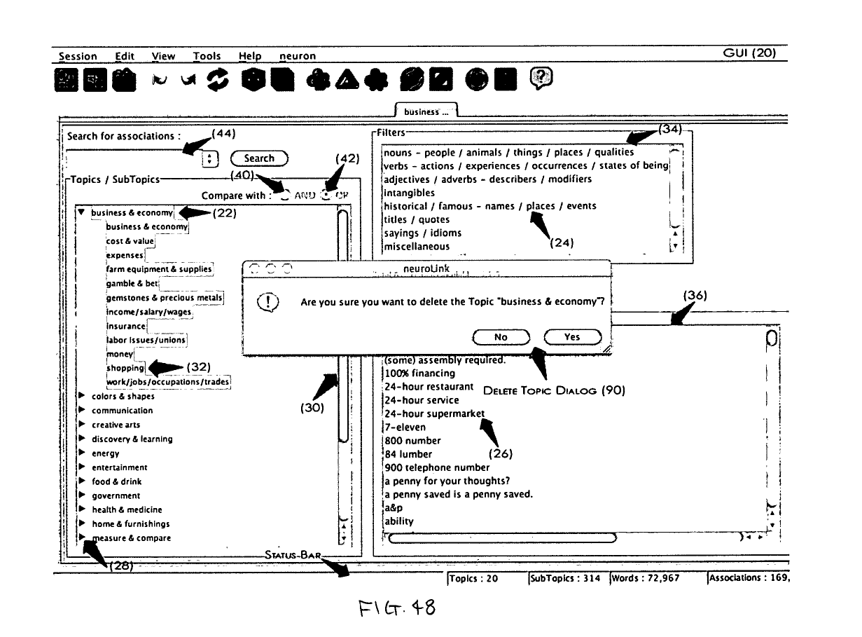

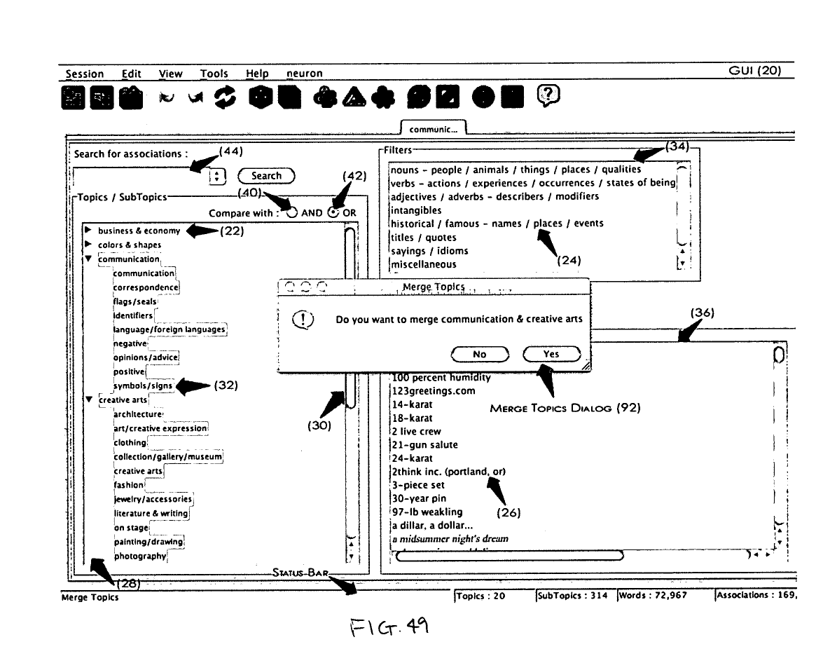

As illustrated in FIG. 43, a user may add a change. For example, as illustrated, the user has input the word “bingo (game)” for change, and has selected the available topic “dogs/canines” and the available filter “nouns” from the available filters list. By selecting the add filter button 74, the selected filter is added to the existing filters list for the word, as illustrated in FIG. 43. Of course, the user might also deleted existing associations, such as existing topic associations or existing filters. FIG. 44 illustrates the result of the user's changes, in which the select topic and filter have been associated with the word. As illustrated, the user's actions are shown in the tracking table 78.

As illustrated in FIG. 45, user changes are preferably displayed in the tracking table 78. The user may undo changes using a remove/restore button 80. The user may also save the changes using a save and new button 82, and close the change session using a close button 84.

It will be appreciated that numerous methods and numerous dialog or window configurations may be utilized to implement the change feature of the invention. For example, a wide variety of means may be provided or utilized to effect the change (i.e. addition or deletion of an association) other than the means described above. For example, double-clicking upon an element may add or delete it, or such may be effected using a menu element. In one embodiment, all associations may be added or removed using a “select all” menu function or the like.

In one or more embodiments of the invention, a user may change a topic. FIG. 46 illustrates a topic contextual menu 86. As illustrated, this menu permits a user to select from various functions, including the renaming of a topic, deleting of a topic, merging of a topic, and adding of a topic or sub-topic. This contextual menu 86 may be displayed from a main menu or by performing a “right-click” upon a selected topic 22.

In one method of the invention, a user may rename a topic. As illustrated in FIG. 47, if the user selects a topic and then selects the rename function (such as from the topic contextual menu 86), then a rename topic dialog or window 88 is displayed. This dialog 88 includes a text box for input of a new name for the selected topic. The user may accept the input topic or reject the input topic by selecting an OK or CANCEL button of the dialog 88.

FIG. 48 illustrates one embodiment of a method of deleting a topic. If a user selects a topic and then selects the delete topic function (such as from the topic contextual menu 86), then a delete topic dialog or window 90 is displayed. This dialog 90 requests confirmation in the form of input from the user that they wish to delete the selected topic.

FIG. 49 illustrates one embodiment of a method of merging topics. A user selects two or more topics. The user then selects the merge topic function (such as from the topic contextual menu 86). As illustrated in FIG. 49, this results in the display of a merge topic dialog or window 92. This dialog 92 requests confirmation in the form of input from the user that they wish to merge the designated topics.

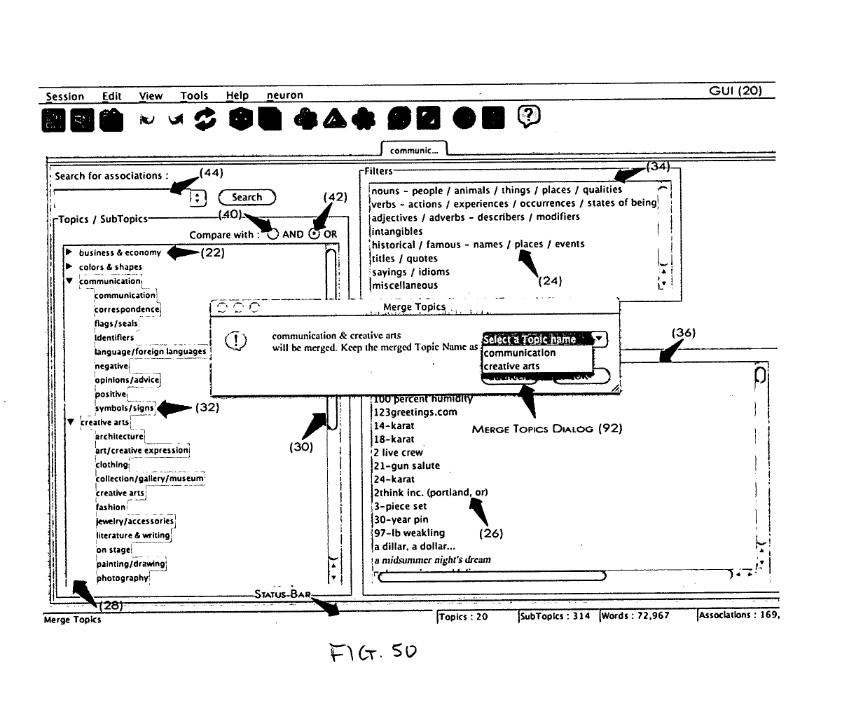

If the user confirms their desire to merge the topics, then as illustrated in FIG. 50, the user is instructed to input the name for the new merged topic. In one embodiment, as illustrated, the user is only permitted to keep one of the existing names for the new merged topic. In another embodiment, the user may be permitted to give a new name to the merged topics.

In one embodiment, a user may be permitted to merge only two topics at a time. In other embodiments, a user may be permitted to merge three or more topics at once.

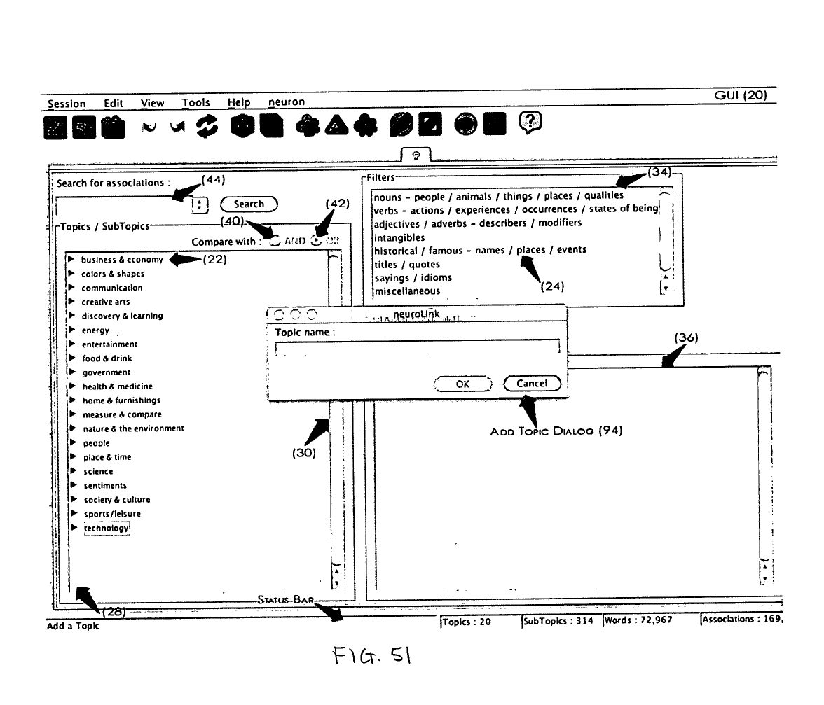

One embodiment of the invention comprises a method of adding a topic. In one embodiment, the user selects the add topic function (such as from the topic contextual menu 86). As illustrated in FIG. 51, this selection results in the display of an add topic dialog or window 94. The add topic dialog 94 includes a text box for input of the new topic which the user wishes to add.

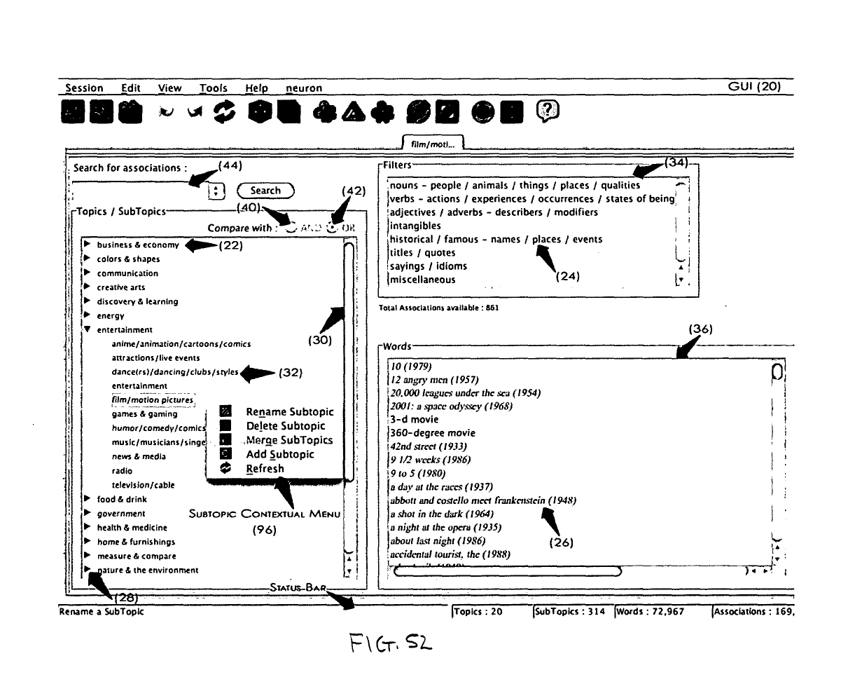

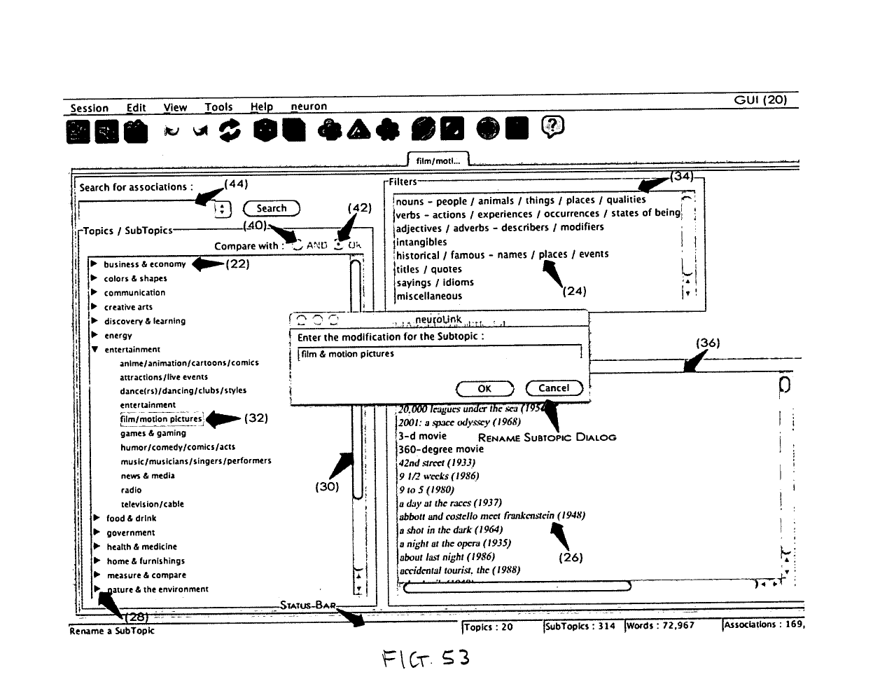

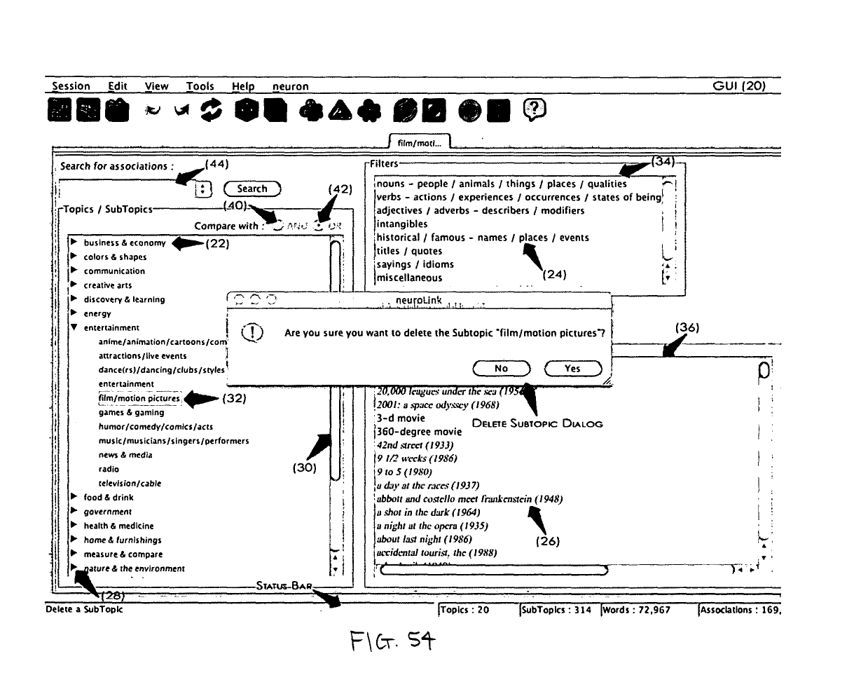

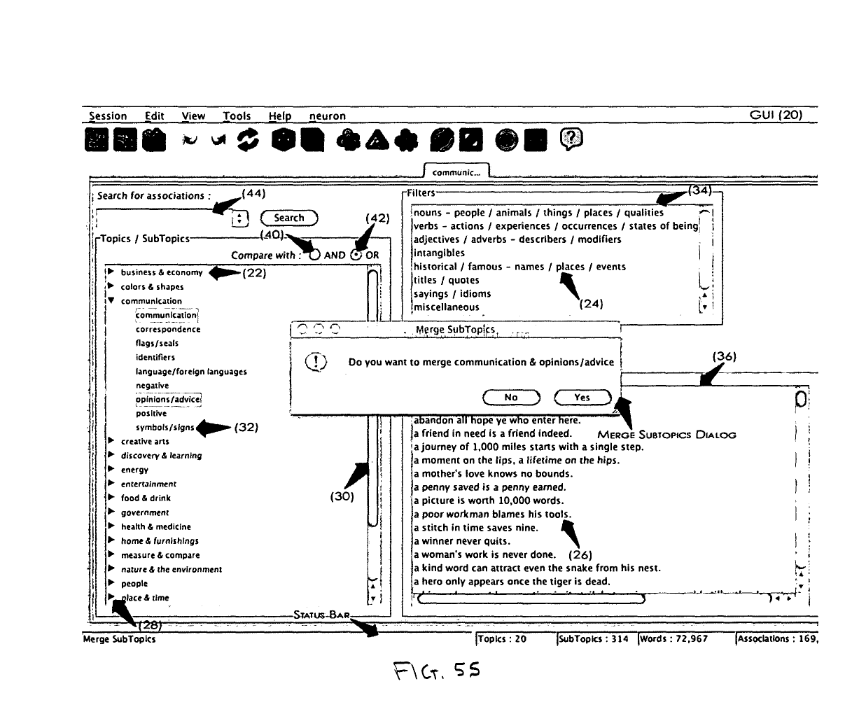

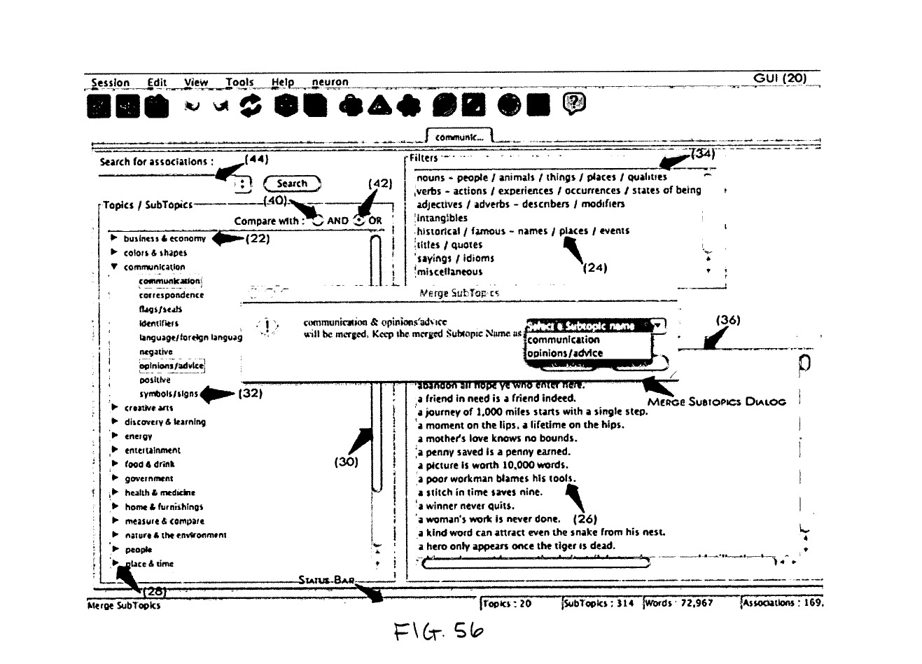

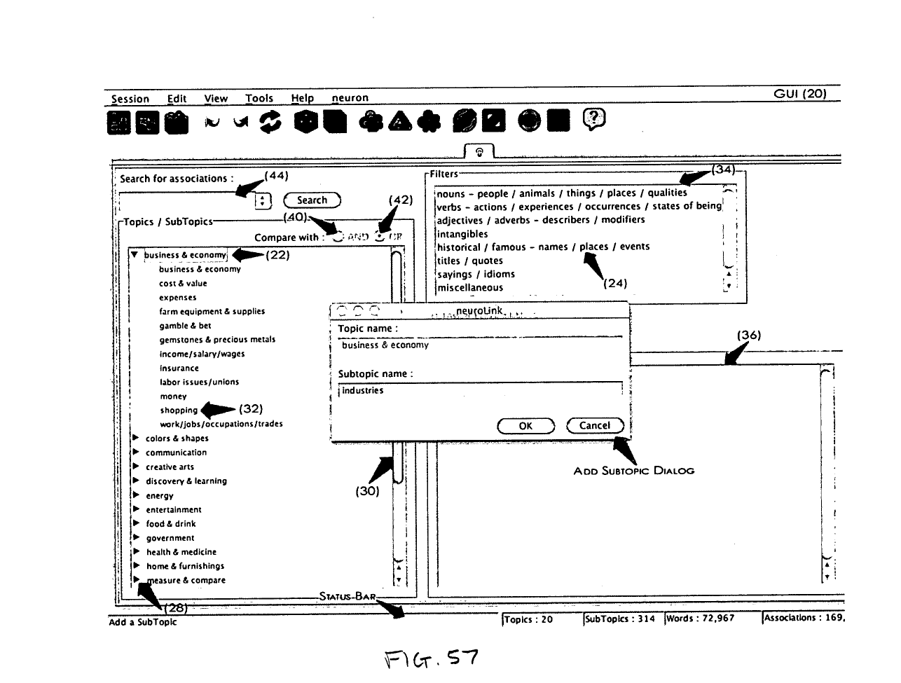

In one or more embodiments of the invention, a user may change a sub-topic 32. FIG. 52 illustrates a sub-topic contextual menu 96. As illustrated, this menu permits a user to select from various functions, including the renaming of a sub-topic, deleting of a sub-topic, merging of a topic, and the addition of a or sub-topic. FIGS. 53-57 illustrate methods of renaming, deleting, merging and adding sub-topics, which methods are similar to those with respect to topics as just described.

It will be appreciated that a variety of other means may be provided for implementing these variety of functions. For example, the graphical user interfaces as described need not be used to implement the addition/change functions described above. These functions could be implemented by a menu item triggering the presentation of particular input boxes or the like.

As detailed above, one particularly advantageous feature of the invention is the ability of the user to customize the data or information including by adding or deleting words, topics/sub-topics and/or filters, and by changeing and/or creating associations. As an additional aspect of the invention, a method and system is provided in which multiple users contribute to the development of a set of data including associated or linked topics/sub-topics, filters and words, phrases or concepts.

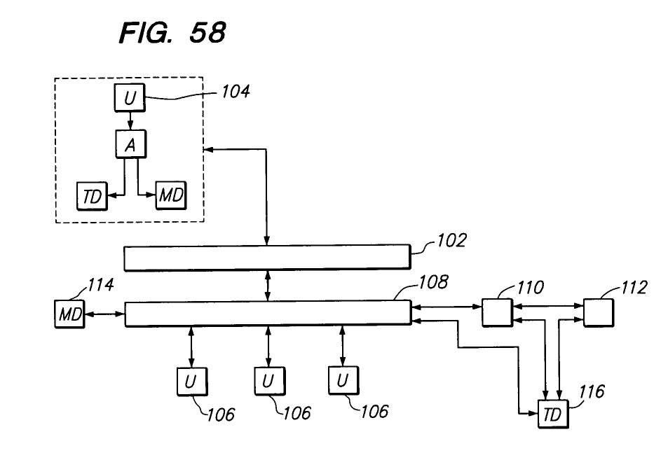

FIG. 58 illustrates one embodiment of a system 100 of the invention. This system 100 may comprise one environment for implementation of various aspects of the invention. As illustrated, the system 100 includes a master or main server or computer 102. The main server 102 may comprise a variety of hardware and/or software, preferably configured to perform various functions described below. The main server 102 includes at least one communication interface (not shown) which permits the server 102 to send and receive information or data.

In one embodiment, the main server 102 includes a storage device, such as a hard drive or other large capacity data storage device. Preferably, this storage device is configured to save one or more databases of words, phrases, concepts, filters, topics, sub-topics and user information, such as user IDs.

In one embodiment of the invention, one or more methods of the invention are implemented by machine readable code or software. A provider supplies the user with the software, such as by license or sale. The user installs the software on a computing device for execution. When executed, for example, the software preferably generates the main graphical user interface 20 as illustrated in FIG. 1.

In one embodiment, as described below, the software may be downloaded by a user, such as from the master server 102. In addition, later application updates may also be downloaded. Of course, the software may be disseminated to the user in other fashions, including on medium such as a CD-ROM or DVD-ROM.

Preferably, the provider maintains the master server 102 and provides a variety of associated services. For example, the provider preferably provides user support, such as in the case of difficultly with the software. One example of a method of the invention in providing such support is described below. In addition, the provider preferably maintains a global database or database(s) of data including the topics/sub-topics, filters, words and other information. As described below, this database information is preferably accessible to the users. The database is preferably updated over time to include more information, including words, topics/sub-topics, filters and new or changed associations. In this manner, the data continues to grow and be an ever more effective tool.

As illustrated, a variety of users may interface with the main server 102. For example, one or more individual users 104 may communicate with the main server 102. As described above, such individual users 104 may be implementing the application described above as software on a home computer. The individual user 104 may communicate with the main server 102 through the Internet or other communication links.

A particular aspect of the invention relates to implementation of the methods of the invention to a group of associated users. In one embodiment, the methods of the invention are implemented with respect to a group of associated users via a network. As illustrated, the network includes a local area network including at least one network server 108. Each of those in the group of associated users who access the network server 108 as part of the implementation of the invention. In one embodiment, a plurality of workstations are provided and may be used by those in the group of associated users accesses the network server 108. For example, a plurality of workstations for supporting one or more group users 106 may be located in a classroom(s) of a school. These workstations may be associated with a network server 108 of the school. Such a configuration may be applied to other groups of users, such as employees of a business or the like.

In one embodiment of the invention, a main network database or databases 114 containing the word, filter, topic/sub-topic and other information as described above is provided for access to the group of users 106. The one or more main network databases 114 may be stored in a storage device associated with the network server 108.

In one embodiment, information is stored regarding input additions and/or changes made by each user to the information contained in the one or more main network databases 114 independently of the additions/changes input by other users to the one or more main databases. In one embodiment, such additions and/or changes are stored in one or more files associated with one or more temporary network databases 116. The one or more temporary network databases 116 are separate from the one or more main or permanent network databases 114 and, except as provided below, the additions and/or changes made by one of the group of users is not accessible by other of the users, and does not affect the one or more main network databases 114.

In this configuration, each use of the group of users may utilize a workstation to access the network server 108. By accessing the network server 108, the user may implement the methods described above, such as word searching, topic searching, filtering and the like. In addition, each user may make additions and/or changes to this data.

One aspect of the invention is a method by which the additions and/or changes of each user of the group of users may be implemented globally.

In one embodiment, the additions and/or changes made by each individual user 106 are stored in the one or more temporary network databases 116. In one embodiment, one or more parties maybe permitted to review the user implemented additions and/or changes and decide whether those additions and/or changes should be implemented in the one or more main network databases 114 for access by all users.

In one embodiment, a two tiered review is provided. In other embodiments, only a single tier review or more than two tiers of review may be utilized.

As illustrated, in one embodiment, an editor 110 is permitted to utilize an editor application to view the user implemented additions and/or changes. The addition and/or change information is obtained from the one or more temporary databases 116. The editor may compare those additions and/or changes to the information stored in the one or more main network databases 114. By such a comparison and the editor's judgment, the editor 110 may determine if one or more of the additions and/or changes should be implemented into the one or more main network databases 114. If so, the selected additions and/or changes are preferably tagged for approval before they are written to the main network database 114.

In one embodiment, the editor 110 may also utilize the editor application to directly make additions and/or changes. Preferably, the directly suggested additions and/or changes are also tagged for approval before they are written to the main network database 114.

In the preferred embodiment, additions and/or changes are only implemented if an administrator 112 approves them. As described above, items for approval are “tagged.” Preferably, the administrator 112 utilizes an administration program to view these items for approval or disapproval. If items are approved, the one or more main network databases 114 are changed to include the changes. The changed main network database 114 is then accessible by all group users 106 as including those changes.

In one embodiment, a log is kept of the user additions and/or changes, including those not approved by the editor 110. The administrator 112 may review that list to determine if he or she wishes to over-ride the editor's decision and incorporate any of those additions and/or changes.

It will be appreciated that the editor 110 and administrator 112 may be wide variety of personnel. For example, in the case of a school, the editor 110 may be a staff person, while the administrator 112 may be a librarian or a school administrator.

The editor 110 and administrator 112 may interact with the networked server 108 in a variety of manners. In one embodiment, the editor 110 and/or administrator 112 may utilize a workstation which has a communication link to the networked server 108. In another embodiment, the networked server 108 may include direct access means, such as a display and keyboard coupled thereto. (The editor and administrator may be the same person.)

In one embodiment, if both the editor 110 and administrator 112 disapprove an addition/change, then that addition/change is not accessible by users other than the user 106 who input the addition and/or change.

In one embodiment, the editor 110 and/or administrator 112 may disapprove an addition entirely. For example, an editor 110 or administrator 112 may wish to completely bar the use of a particular addition/change, such as a new word added by a user.

It will be appreciated that the editor 110 and/or administrator 112 may apply a wide variety of criteria for determining if an addition and/or change should be implemented to the one or more main network databases 114.

In accordance with this aspect of the invention, a plurality of users contribute to the growth and development of a database(s) of information for use in accordance with the method. In this manner, the database of words, filters, topics/sub-topics and associations between these elements grows over time to be more comprehensive and complete. In accordance with this method, the database(s) is also permitted to change over time to reflect cultural issues, such as new words which become accepted into language, or new events or concepts that occur over time.

As another aspect of the method and system 100 described, an administrator 112 may track the activities of users 106 in a group of users. For example, in a school setting, an administrator 112 may track the activities of an individual user. In one embodiment, users in the group of users may be awarded points or credits for suggesting additions and/or changes which are approved for addition to the master database. The points or credits may provide intrinsic satisfaction to the user, or the points or credits may be redeemed for prizes, awards or the like. In either event, the points or awards may be useful in fueling the desire of individual users to make suggested additions and/or changes.

In one embodiment, in such a networked environment, users may be required to identify themselves. For example, each student at a school or employee of a company may be required to obtain a user identifier. The identifier may comprise, for example, a user ID and a password. When the student or employee wishes to utilize the application, such as at a particular workstation, the student or employee may be required to provide their user identifier. All activities during a session, such as the user's searches, additions and/or changes, are preferably identifiable by association of the user's user identification with such information.

In this manner, the editor 110 and/or administrator 112 may determine the identity of each user for each particular transaction, such as each input addition/change. Utilizing this user information, the editor 110 and/or administrator 112 may cull additional information. For example, the editor 110 and/or administrator 112 may associate particular use information with information or characteristics known about the user. The editor 110 and/or administrator 112 may determine, for example, differences in activities between male and female users or differences in activities between users of different age groups. Such information may be utilized for a variety of purposes.

It will be appreciated that the system 100 just described may be implemented in a variety of fashions. In one embodiment, for example, a main database or databases for the entire group of users 106 may be stored at the network server 108. Each user of the group of users may thus access the main database or databases.

In accordance with the invention, there is a method and system for providing updated database information to all users. Preferably, each individual user 104 and each group user 106 has at one or more times access to a globally updated database of information. In one embodiment, updated data is provided to individual users 104 and/or to group users 106 at request or automatically. For example, a user may manually check for updated data, such as by establishing a communication link with the master server 102. In one embodiment, software may be provided for establishing such a contact from the user end at one or more times.

In another embodiment, the master server 102 may contact users, such as by sending a signal indicating that updated data is available.

In one embodiment, globally updated data may be generated in a variety of manners. First, the provider, such as the party operating the master server 102, may make additions and/or changes to the data. In similar manner to that described above, personnel working for the provider may suggest additions and/or changes and those additions and/or changes may be reviewed by an editor and/or administrator before implementation.

In a preferred embodiment, the provider collects additions and/or changes implemented by individual users 104 and group users 106. In one embodiment, when an individual user 104 seeks updated data, the master server 102 polls the user's database to determine the user's additions and/or changes. That information is then reviewed and, if approved, is passed on to the contributor of the data.

In the case of group users 106, the one or more main network databases 114 are preferably updated with updated data from the master server 102 at one or more times. Once again, when such occurs, changes implemented to the one or more main network databases 114, such as those approved by the administrator 112, are provided.

In this embodiment, additions and/or changes to the data provided by many individual and/or group users is used to build an ever increasing amount of data. It will also now be appreciated that the tool of the present invention is dynamically evolving. The tool evolves in the sense that it changes over time, with new topics, sub-topics and words being added and new associations being made. This evolution is dynamic in the sense that the changes are effected continuously by the various users of the tool. This aspect of the invention is very important. Because the tool dynamically evolves, its ability to be useful to the user increases over time. As the user's memory is stimulated and the user uses the tool, the user's ability to change or evolve the tool improves. Importantly, the tool of the invention can evolve or change along with society. For example, as language changes within society, so does the tool. This maintains the tool's usefulness, keeping it in step with the user and the user's needs.

A number of other aspects of the invention will now be described. As detailed above, in one embodiment the methods of the invention may be implemented with computer readable program code. A user of that code or software may at one or more times require help or assistance.

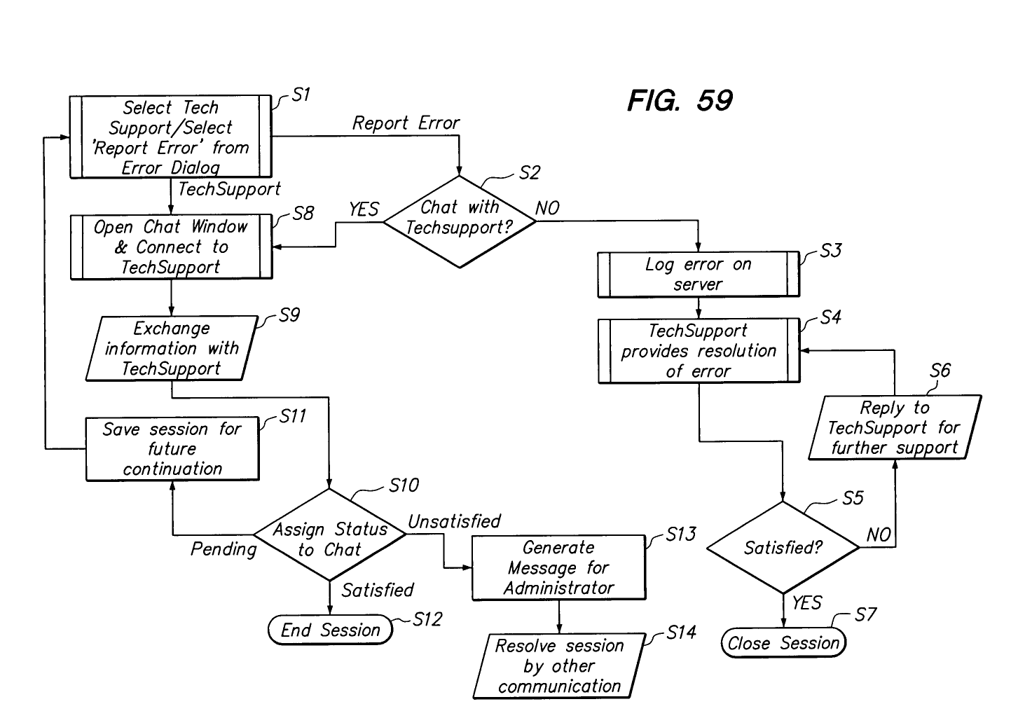

In accordance with one embodiment of the invention, there is an improved method for providing user assistance or support, including reporting errors. One method will be described in conjunction with FIG. 59. In accordance with the method, in a first step SI, a user invokes the “technical assistance” function. In one embodiment, this comprises selecting a “help” menu element, such as displayed in the graphical user interface (see FIG. 1). The user may invoke this function when an error has occurred or when they are experiencing difficulties. In the event of an error, a message may be displayed to the user providing notification of the error, such as via a dialog box. This message may allow the user to invoke the assistance function or continue working.

In a step S2, if the function is invoked in response to an error, it may be determined if the user wishes to establish a communication link directly with technical assistance or simply report the error. In a step S3, if the user simply reports the error, then information regarding the error is preferably transmitted from the user's computer to a remote device.

In a step S4, technical support or assistance preferably reviews the information regarding the error and attempts to provide resolution to the error. The resolution may be, for example, creating a software patch which rectifies the problem. Preferably, information regarding the solution is provided to the user, such as via an email message.

In a step S5, if the user is not satisfied with the solution, the user may, in a step S6, reply to technical assistance and indicate this fact. The user may reply, for example, by email. This preferably causes technical support to again analyze the problem and attempt once again to resolve the problem.

In at step S5 the user is satisfied with the result, then in a step S7, the session ends.

If the user invokes the technical assistance or “help” function for other than an indicated error, or if in the case of an indicated error the user wishes to directly communicate with technical support, then in accordance with a second step S8, a window is displayed to the user. As applied to the application of the present invention, in one embodiment, this step comprises generating and displaying a new window apart from the main graphical user interface 20. This window preferably comprises a box or area where information may be displayed.

In addition, a communication link is established between the user and a technical support person. In one embodiment, the communication link is established between the user's computer and a computing device used by a technical support person. The communication link may be established in a variety of manners known to those of skill in the art. For example, in the case of a single user having a communication link to the Internet, the application may utilize that communication link and utilize a call function to locate a technical support person using a predetermined address, such as a web server or email address. In the case of a group user, the communication link may extend through a local area network. Of course, a dedicated connection, such as by direct dial over a phone line, could also be used.

Preferably, the communication link is established with a technical support person who is knowledgeable regarding the application and can thus respond to questions regarding the application. These questions may pertain to installation, trouble-shooting, feature use and other issues.

In a step S9, information is exchanged between the user and the technical support person. In one embodiment, the user transmits information regarding a topic or issue. For example, the user may detail a problem he or she is having. In one embodiment, the information is exchanged in live “chat” format. In this format, the user inputs the information. This information is preferably displayed in the text box. The information is transmitted to the technical support person. The technical support person then responds by transmitting information back to the user. This information is displayed in the text box to the user.

In this configuration, the user obtains real-time information, including answers to problems. A particular advantage of this configuration is that the information is displayed in the window to the user for later use. The later use may include, for example, printing for archive purposes. This avoids the user losing or forgetting information, as might be the case if the information were obtained via a telephone conversation.

In a preferred embodiment, in a step S10, at the end of a session the user is prompted to indicate the status of the session. In one embodiment, this prompt may be displayed to the user with particular choices such as “issues resolved satisfactorily” or “my issues were not resolved.” Of course, other means may be provided for indicating the status of the session.

In a step S10, if the status of the session is indicated as resolved, then in a step S12, the session is closed. This may comprise termination of the communication link. In one embodiment, the window remains open so that the user may continue to view, print or otherwise utilize the information exchanged. On the support-side, the session information may be stored in one or more files.

In step S10 if the session is indicated as not resolved, then in a step S13 a message is preferably generated. This message is preferably forwarded to a higher level of support personnel, and includes the information exchanged during the session as well as the indicated status of the session. This message may be forwarded, for example, to a supervisor.

In a step S14, the session is preferably resolved. This may comprise providing additional information or support to the user. The information may be provided as part of the same session, or the user may be contacted at a later time, including by telephone or other means.

In one embodiment, the user may indicate in step SI 0 that the status of the session is “pending.” For example, the user may be provided with information and the user may need to attempt to use that information to solve the problem. The user may then report the results of the solution as either “satisfied” or “unsatisfied.” Thus, if a session is indicated as “pending,” in a step S11, the session information is preferably stored for future reference. In one embodiment, the session may be assigned an identifier so that the associated information may readily be obtained.

The method of the invention may be implemented in a variety of fashions. For example, the particular protocol used to exchange the information may vary. In one embodiment, the information exchanges in a live “chat” format using HTTP, but the data could be exchanged using other protocols.

Other means may also be utilized for providing support to a user. For example, a user may send an email to a technician. Alternatively, the user could call a technical assistance line. The provider might also provide a website or other location where information may be posted for access by a user. In this regard, in one embodiment of the invention a database of questions and answers or other assistance information, such as tips, may be maintained. This database may be accessible by the user for “self-help” assistance. Support personnel may also utilize this database when responding to user inquiries.

In one embodiment, an internal database of information may be maintained for use by support personnel. This database may be updated by support personnel. For example, in the course of responding to a user, a problem may be identified which was yet unidentified. The support personnel responding to the problem may add the problem and solution to the database for use by others at a later date.

One aspect of the invention is a method for confirming the identity of the party obtaining software for implementing the application and/or for utilizing the application, or updates or other information, such as topic/sub-topic, filter and word data. It will be appreciated that this method may be applied to other applications/software.

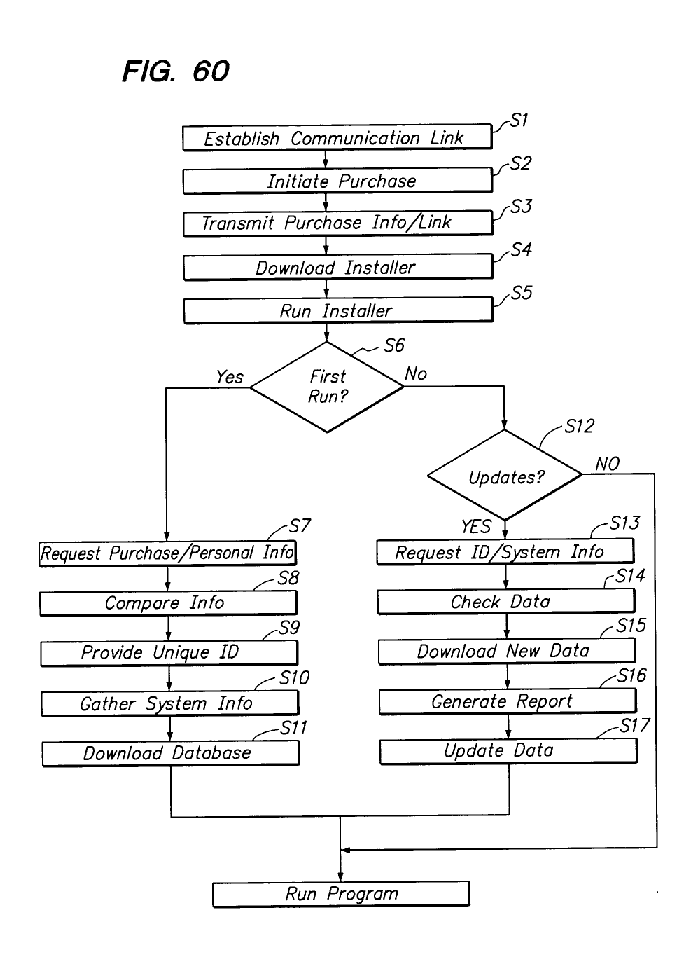

One embodiment of the invention will be described with reference to FIG. 60. In one embodiment, software for implementing the application may be obtained and, at one or more times, updated application code or updated data is provided or obtained. This method may be implemented via a system such as that illustrated in FIG. 58.

In one method, in step SI, a communication link is established between the user's computer or device and a provider device. The provider device may comprise, for example, a server. The communication link may comprise the Internet, a dedicated line or other means.

In a second step S2, the user initiates the purchase of the software/data. In one embodiment, this comprises the user providing monetary value, such as by credit card authorization or the like. Preferably, at the time of purchase, the user provides certain personal information. This information may comprise the user's name and address.

In a step S3, purchase information is preferably transmitted to the user. In one embodiment, this step comprises the provider sending purchase confirmation information, such as a purchase code, back to the user. Preferably, the information also includes a link or address for obtaining the application. In one embodiment, this purchase information may be transmitted to the user via e-mail. In one embodiment, the link comprises a web address for a server configured to transmit application data.

In a step S4, the application is transmitted to the user. In one embodiment, this comprises the user establishing a communication link with the designated download location, such as by inputting the web address into a web browser. Preferably, when this link is established, data representing the application is transmitted to the user. This data is preferably stored at the user's computer, such as on a hard drive or other data storage device, such as a disk.

In one embodiment, the data includes an installer module or program. This installer program is an executable file which installs or instantiates the application onto the user's computer, allowing it to be executed or run by the user's operating system.

In a step S5, the user installs the application. In one embodiment, this comprises running the installer, causing the installer to install the application.

In step S6, the application is executed or run. In one embodiment, when the application is installed, the application may open or run automatically at the end of the installation process. In this step S6, it is determined if the application is being run for the first time.

If in step S6 it is determined that the application is being run for the first time, then an authentication procedure for verifying entitlement to application data is executed. In a step S7, the user is requested to transmit purchase and personal information. The user inputs the purchase information, such as a purchase code provided in step S3, as well as certain personal information, such as their name and address.

In a step S8, the provided purchase and personal information is used to determine the authenticity of the purchase. For example, the purchase and personal information may be compared to information stored in a master database belonging to the provider.

In a step S9, if authenticity of the purchase is confirmed, a user identification (ID) is generated and transmitted to the user.

In a step S10, information is obtained regarding the user's computer or device. This step may comprise the provider polling information from the user's computer, such as information regarding the size of the user's hard drive, amount of RAM, operating system and the like. This information is preferably transmitted to the provider and is stored for future use. In one embodiment, one or more files are created and data regarding the user is associated with those files. This information my include the user's purchase information, personal information, assigned ID, and system information.

In a step S11, data is transmitted to the user. Preferably, this data comprises a database of the information described above, namely word, topic, sub-topic, and filter information. Once this information is provided to the user, it is accessible by the application, permitting the functionality described above.

In the future, when the user runs the application, in step S6 it is determined that the application is not being run for the first time. In that event, in a step S12, the application preferably checks for updates. In one embodiment, the application is preferably configured to establish a communication link with the provider, such as by using an open communication link between the user's device and the Internet. The application may be configured, for example, to contact an update server. In other embodiments, in step S12, the application only checks for updates at certain time intervals, such as after a predetermined period of time has elapsed, or after the application has been run a certain number of times.

If no updates are available, then the application may simply run. In a step S13, if an update is available, then the user is preferably prompted to provide their user ID. System information from the user's computer is also transmitted to the provider.

In step S14, the user's ID and system information is check against stored data. As indicated, the stored data may be maintained in one or more files in a master database.

In a step S15, if the user's ID and system information are verified, then updated data is transmitted or downloaded to the user. If the user's ID and/or system information is not verified, then the user may be requested to enter their ID again. If the user's system information is not verified, the user may be requested to contact customer assistance, as a change to the user's system may have altered the current system information compared to the stored information.

In one embodiment, if the user's ID and /or system information is not verified, a warning is displayed to the user. The warning may indicate to the user that unauthorized use of the application/data is a violation of law and requesting that the user contact the administrator to either correct their information if they are a paid user or to provide payment to become an authorized user. In one embodiment, a message is transmitted to the administrator/system containing the time and the IP address of the user, identifying the user as an unauthorized user.

In a step S16, a report is preferably generated and provided to the user. This report preferably provides the user with information regarding the comparison of the provided updated data to the user's current data. For example, a user may have already input a specific change to their database which is being provided by the update. The user is alerted to this fact and may be provided the opportunity to select whether they wish for the change to supercede the update. As one example, a user may have merge two topics. The updated data might overwrite that merge and re-install two individual topics. The user may be provided with a “check-list” type report which includes this identified difference, permitting the user to keep the original merged topic.

In a step S17, the updated data is preferably installed for use by the user's application. The updated data is preferably installed based upon the user's input regarding the generated report.

Lastly, the application is preferably executed, permitting the user to engage in one or more of the functions or methods described above.

In one embodiment of the invention, networked applications are treated as single or individual users. As such, each networked application maybe provided with a single client ID which is used to gain access to application and database updated. As described above, each user of the networked application may be provided an individual user password or ID, identifying each user of the group of users on the networked application. In this manner, the individual updates or preferences of the users of the group of users of a networked application can be identified. At the same time, the entire networked application is treated as a single user to the master database, so updates are provided based upon identification of the single networked application.

As another aspect of the invention, as described above, a temporary or personal database may be utilized in addition to each master. As described, the networked application includes both a temporary network database 116 and a main network database 114. The temporary network database 116 contains individual user change information. Likewise, each individual application preferably includes both a main database and a temporary database, with the temporary database including user change information (see FIG. 58).

As indicated, in one embodiment, when a database update is provided to the user (whether an individual or networked application), that update is compared to the user's temporary database (see step S15, FIG. 60). The updated data is compared to the user's data to determine the differences between the data. Any differences are noted in a report to the user. The report preferably allows the user to accept or reject data changes based upon the updated data. For example, a user may have changed the database by merging two topics. The updated data set may include both separate topics. The report denotes to the user this difference, and allows the user to elect to either keep their change (i.e. keep the merged topic data) or overwrite their data with the new updated data (which includes two separate topics).

It will be appreciated that this method may be applied to a variety of other environments or applications. In general, this method may be applied to any software-based application executed in a computing environment. This may include, for example, PDA's and cell phones.

As described above, features of the invention are implemented in a windows-type graphical user interface. As is known, such windows may have features such as a “reduce” or “minimize” size of window, “restore” and “close” window feature. The various functions may be implemented by selecting elements displayed in the window or by using menus or menu elements. The window or windows may include other well-known features of windows-type graphical user interfaces, such as a status bar.

It will be understood that the above described arrangements of apparatus and the method therefrom are merely illustrative of applications of the principles of this invention and many other embodiments and changes maybe made without departing from the spirit and scope of the invention as defined in the claims.

1. A system useful in assisting in memory recall and idea generation comprising:
at least one database, said at least one database containing:
information regarding a plurality of topics;
information regarding one or more sub-topics, each sub-topic associated with at least one topic;
information regarding a plurality of filters;
information regarding a plurality of words, concepts or phrases; and
information associating the plurality of words, concepts or phrases with at least one topic or sub-topic and at least one filter;
means for generating a first output of words, concepts or phrases upon the selection of one or more topics or sub-topics;
means for filtering said first output to generate a changed second output upon the selection of at least one particular filter
means for generating a third output of words, concepts or phrases upon the selection of only at least one filter; and
means for generating and displaying a fourth output comprising the one or more topics or sub-topics and words with which a particular word or words are associated.

2. The system in accordance with claim 1 including means for generating a graphical user interface, said graphical user interface including a topic/sub-topics list in which topic and sub-topic information is displayed, a filters list in which filter information is displayed, and a words list in which words, phrases or concepts may be displayed.

3. The system in accordance with claim 2 wherein one or more of the words, concepts or phrases are associated with more than one topic, sub-topic or filter.

4. The system in accordance with claim 1 wherein said filters include nouns, verbs, and adjectives.

5. The system in accordance with claim 1 wherein said means for generating said first output of words, concepts or phrases comprises means for outputting words, concepts or phrases which are associated with said selected topics or sub-topics.

6. The system in accordance with claim 1 wherein said means for generating said third output of words, concepts or phrases comprises means for outputting a list of all words, concepts or phrases associated with said selected filter.

7. The system in accordance with claim 1 wherein said means for displaying comprises means for visually distinguishing the one or more topics or sub-topics by a visual identifier.

8. The system in accordance with claim 1 including means for displaying a list of related word to an input word.

9. A method of creating a database of topics, sub-topics, and filters and words, phrases and concepts associated with one or more of the topics, sub-topics and filters, comprising the steps of:
providing at least one master database of words, phrases or concepts associated with said topics, sub-topics and filters;
implementing said master database as a main user database;
permitting at least one user to access said main user database;
accepting input from a user regarding additions or changes to said main user database;
screening said additions or changes to said main user database;
changeing said main user database if said additions or changes are approved by a third party;
polling said main database and comparing said main database as changed by said additions or changes to said master database; and
selectively implementing one or more of said additions or changes made to said main database which do not exist in said master database.

10. The method in accordance with claim 9 wherein said master database is maintained by a provider and said main database is utilized by a group of users, and wherein said step of implementing said master database comprises transmitting said master database to said group of users and permitting said users of said group of users to access said main user database.

11. The method in accordance with claim 10 wherein said third party comprises an administrator of said group of users.

12. The method in accordance with claim 9 wherein said screening step includes the step of displaying input additions or changes and selectively approving each addition or change.

13. The method in accordance with claim 12 including the step of changeing said main user database only after two parties have screened and approved said additions or changes.

14. The method in accordance with claim 10 wherein said polling step occurs when a user establishes a communication link with a provider managing said master database.

15. The method in accordance with claim 9 including the step of creating at least one secondary user database, said at least one secondary user database including input regarding additions and changes, which additions and changes may be accessed by said at least one user but which are not part of said main user database until said main user database is changed.

16. A method of providing user assistance in a computing environment comprising the steps of:
presenting information to a user of an application at a user computing device;
accepting input from said user of said application regarding a request for assistance; and
engaging in a user-assistance session comprising the steps of:
establishing a communication link between said user's computing device and a provider device;
generating an information display window at said user computing device;
accepting input from said user of a request for assistance, said request displayed in said display window;
transmitting said request to said provider device over said communication link;
generating a response to said request;
transmitting said request from said provider device to said user computing device over said communication link; and
displaying said response to said user in said display window.

17. The method in accordance with claim 16 including the step of accepting input from said user regarding an outcome of said session.

18. The method in accordance with claim 17 wherein said input indicates that said outcome of said session was not acceptable to said user, generating a message including said input outcome and said request and response, and generating a secondary response to said user.

19. The method in accordance with claim 18 wherein said secondary response comprises a separate communication contact by said provider to said user.

20. The method in accordance with claim 16 including the step of continuing to transmit information from said user to said provider and from said provider to said user until said session ends.
